(19) United States
(12) Patent Application Publication
(10) Pub. No.: US 2024/0324058 A1
(43) Pub. Date: Sep. 26, 2024

(54) DISCONTINUOUS TRANSMISSION AND RECEPTION BETWEEN NETWORK ENTITIES

(71) Applicant: QUALCOMM Incorporated, San Diego, CA (US)

(72) Inventors: Huilin XU, Temecula, CA (US); Diana MAAMARI, San Diego, CA (US); Ahmed ELSHAFIE, San Diego, CA (US)

(21) Appl. No.: 18/187,606

(22) Filed: Mar. 21, 2023

(51) Int. Cl. H04W 76/28; H04W 72/12; H04W 72/20

(52) U.S. Cl. CPC H04W 76/28; H04W 72/12; H04W 72/20

(57) ABSTRACT

Systems and techniques are provided for wireless communications. A first network entity (e.g., a user equipment (UE)) may receive information indicative of a first discontinuous reception (DRX) configuration and information indicative of a second DRX configuration. The first DRX configuration is indicative of a first DRX on-duration of the first network entity. One or more DRX configuration parameter values of the second DRX configuration are different from one or more DRX configuration parameter values of the first DRX configuration. The first network entity determines a discontinuous transmission (DTX) enabled state of a second network entity (e.g., a base station, such as a gNodeB (gNB)). The DTX enabled state corresponds to a DTX on-duration of the second network entity. The first DRX on-duration is within the DTX on-duration of the second network entity. The first network entity receives, from the second network entity, downlink information during the first DRX on-duration.

### FIELD

Aspects of the present disclosure generally relate to wireless communication. In some implementations, examples are described for discontinuous transmission (DTX) and discontinuous reception (DRX) between network entities.

### INTRODUCTION

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one example, a first network entity for wireless communication is provided. The first network entity includes at least one memory and at least one processor coupled to the at least one memory. The at least one processor is configured to: receive information indicative of a first discontinuous reception (DRX) configuration for the first network entity, wherein the first DRX configuration is indicative of a first DRX on-duration of the first network entity; receive information indicative of a second DRX configuration for the first network entity, wherein one or more DRX configuration parameter values of the second DRX configuration are different from one or more DRX configuration parameter values of the first DRX configuration; determine a discontinuous transmission (DTX) enabled state of a second network entity, wherein the DTX enabled state corresponds to a DTX on-duration of the second network entity, and wherein the first DRX on-duration is within the DTX on-duration of the second network entity; and receive, from the second network entity, downlink information during the first DRX on-duration.

In another illustrative example, a method of wireless communication at a first network entity is provided. The method includes: receiving information indicative of a first discontinuous reception (DRX) configuration for the first network entity, wherein the first DRX configuration is indicative of a first DRX on-duration of the first network entity; receiving information indicative of a second DRX configuration for the first network entity, wherein one or more DRX configuration parameter values of the second DRX configuration are different from one or more DRX configuration parameter values of the first DRX configuration; determining a discontinuous transmission (DTX) enabled state of a second network entity, wherein the DTX enabled state corresponds to a DTX on-duration of the second network entity, and wherein the first DRX on-duration is within the DTX on-duration of the second network entity; and receiving, from the second network entity, downlink information during the first DRX on-duration.

In another illustrative example, a non-transitory computer-readable storage medium comprising instructions stored thereon which, when executed by at least one processor, causes the at least one processor to: receive information indicative of a first discontinuous reception (DRX) configuration for the first network entity, wherein the first DRX configuration is indicative of a first DRX on-duration of the first network entity; receive information indicative of a second DRX configuration for the first network entity, wherein one or more DRX configuration parameter values of the second DRX configuration are different from one or more DRX configuration parameter values of the first DRX configuration; determine a discontinuous transmission (DTX) enabled state of a second network entity, wherein the DTX enabled state corresponds to a DTX on-duration of the second network entity, and wherein the first DRX on-duration is within the DTX on-duration of the second network entity; and receive, from the second network entity, downlink information during the first DRX on-duration.

In another illustrative example, an apparatus is provided for wireless communication at a first network entity. The apparatus includes: means for receiving information indicative of a first discontinuous reception (DRX) configuration for the first network entity, wherein the first DRX configuration is indicative of a first DRX on-duration of the first network entity; means for receiving information indicative of a second DRX configuration for the first network entity, wherein one or more DRX configuration parameter values of the second DRX configuration are different from one or more DRX configuration parameter values of the first DRX configuration; means for determining a discontinuous transmission (DTX) enabled state of a second network entity, wherein the DTX enabled state corresponds to a DTX on-duration of the second network entity, and wherein the first DRX on-duration is within the DTX on-duration of the second network entity; and means for receiving, from the second network entity, downlink information during the first DRX on-duration.

In another illustrative example, a first network entity for wireless communication is provided. The first network entity includes at least one memory and at least one processor coupled to the at least one memory. The at least one processor is configured to: transmit information indicative of a first discontinuous reception (DRX) configuration for a second network entity, wherein the first DRX configuration is indicative of a first DRX on-duration of the second network entity; transmit information indicative of a second DRX configuration for the second network entity, wherein one or more DRX configuration parameter values of the second DRX configuration are different from one or more DRX configuration parameter values of the first DRX configuration; determine a discontinuous transmission (DTX) enabled state of the first network entity, wherein the DTX enabled state corresponds to a DTX on-duration of the first network entity, and wherein the first DRX on-duration is within the DTX on-duration of the first network entity; and transmit, to the second network entity, downlink information during the first DRX on-duration.

In another illustrative example, a method of wireless communication at a first network entity is provided. The method includes: transmitting information indicative of a first discontinuous reception (DRX) configuration for a second network entity, wherein the first DRX configuration is indicative of a first DRX on-duration of the second network entity; transmitting information indicative of a second DRX configuration for the second network entity, wherein one or more DRX configuration parameter values of the second DRX configuration are different from one or more DRX configuration parameter values of the first DRX configuration; determining a discontinuous transmission (DTX) enabled state of the first network entity, wherein the DTX enabled state corresponds to a DTX on-duration of the first network entity, and wherein the first DRX on-duration is within the DTX on-duration of the first network entity; and transmitting, to the second network entity, downlink information during the first DRX on-duration.

In another illustrative example, a non-transitory computer-readable storage medium comprising instructions stored thereon which, when executed by at least one processor, causes the at least one processor to: transmit information indicative of a first discontinuous reception (DRX) configuration for a second network entity, wherein the first DRX configuration is indicative of a first DRX on-duration of the second network entity; transmit information indicative of a second DRX configuration for the second network entity, wherein one or more DRX configuration parameter values of the second DRX configuration are different from one or more DRX configuration parameter values of the first DRX configuration; determine a discontinuous transmission (DTX) enabled state of the first network entity, wherein the DTX enabled state corresponds to a DTX on-duration of the first network entity, and wherein the first DRX on-duration is within the DTX on-duration of the first network entity; and transmit, to the second network entity, downlink information during the first DRX on-duration.

In another illustrative example, an apparatus is provided for wireless communication at a first network entity. The apparatus includes: means for transmitting information indicative of a first discontinuous reception (DRX) configuration for a second network entity, wherein the first DRX configuration is indicative of a first DRX on-duration of the second network entity; means for transmitting information indicative of a second DRX configuration for the second network entity, wherein one or more DRX configuration parameter values of the second DRX configuration are different from one or more DRX configuration parameter values of the first DRX configuration; means for determining a discontinuous transmission (DTX) enabled state of the first network entity, wherein the DTX enabled state corresponds to a DTX on-duration of the first network entity, and wherein the first DRX on-duration is within the DTX on-duration of the first network entity; and means for transmitting, to the second network entity, downlink information during the first DRX on-duration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6A is a diagram illustrating an example of aligned user equipment (UE) discontinuous reception (DRX) configurations, in accordance with some examples;

FIG. 6B is a diagram illustrating an example of non-aligned UE DRX configurations, in accordance with some examples;

FIG. 7 is a flow diagram illustrating an example of a process for wireless communications, in accordance with some examples;

FIG. 8 is a flow diagram illustrating another example of a process for wireless communications, in accordance with some examples; and

FIG. 9 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

The energy efficiency of wireless communication between client devices (e.g., UEs, etc.) and base stations (e.g., gNBs, etc.) can vary based on various different factors. As used herein, the “energy efficiency” associated with wireless communications at a UE or base station may be referred to interchangeably as the “power consumption” associated with the wireless communications at the UE or base station.

Power consumption for wireless communications can include a power consumption associated with transmitting wireless signals and a power consumption associated with receiving wireless signals. For example, a UE power consumption can include the power consumption associated with the UE actively transmitting wireless signals (e.g., to a base station or gNB) and the power consumption associated with the UE actively receiving wireless signals (e.g., from a base station or gNB).

In addition to the power consumption associated with actively transmitting or receiving, a UE additionally consumes power while in an active or ‘On’ state where the UE is configured to be continuously ready to transmit or receive data. For instance, a UE consumes power while waiting to receive data from a base station or gNB, even when no data is being transmitted by the base station or gNB. The UE remains continuously awake in order to decode downlink data, as the data in the downlink may arrive at any time. The UE may monitor a physical downlink control channel (PDCCH) in every subframe to check whether a PDCCH is available scheduling or otherwise indicating downlink data for the UE. Continuously monitoring PDCCH for possible downlink (DL) and/or uplink (UL)data, the UE may consume a large portion of the available power at the UE (e.g., a large portion of the available battery power at the UE).

In some cases, power saving techniques can be implemented for client devices, for base stations, and/or for a combination of the two. Some power saving techniques are based on managing the energy efficiency or energy consumption of various periodic communications between UEs and base stations. For example, discontinuous reception (DRX) can be used to configure PDCCH periodic monitoring, where a UE wakes up to monitor for downlink data during a periodic DRX-enabled state and enters a low-power sleep or idle mode outside of the periodic DRX-enabled state (e.g., during a DRX-disabled state). Discontinuous transmission (DTX) can be used to configure periodic transmission of uplink signals by a UE (e.g., during a periodic DTX-enabled state), where the UE enters the low-power sleep or idle mode outside of the periodic DTX-enabled state (e.g., during a DTX-disabled state).

In some cases, DRX implemented by a UE can also be referred to as connected mode DRX, and may be used to improve UE battery power consumption based on the UE periodically entering a ‘sleep’ state for an ‘off-duration’ during which the UE does not monitor PDCCH. To monitor PDCCH for possible downlink/uplink data, the UE can be configured to wake up periodically and remain in an ‘awake’ state for an ‘on-duration.’ DRX implemented by a UE can also be referred to as “UE-DRX.”

In some cases, DRX can be implemented by a base station or gNB as an energy saving mode for discontinuous reception of UE uplink transmissions by the base station or gNB. DRX implemented by a base station or gNB can also be referred to as “cellular-DRX” and/or “cell-DRX.” When cell-DRX is enabled, a gNB can stop monitoring for UL transmissions from UEs that are associated with a cell that is currently in the cell-DRX-off state.

In some cases, a UE may generate and transmit one or more UL transmissions during a UE-DRX-on state (e.g., the on-duration of the UE-DRX cycle) and/or during a UE-DRX-off state (e.g., the off-duration of the UE-DRX cycle). For example, a UE may transmit periodic channel state information (CSI) or sounding reference signals (SRS) (e.g., among various other signals and/or transmissions), which may cause a base station to assign resources to monitor for CSI or SRS transmissions from the UE.

When cell-DRX is enabled, the base station or gNB will receive UL transmissions from UEs that arrive during the cell-DRX-on state (e.g., the on-duration of the cell-DRX cycle). The base station or gNB will not receive UL transmissions from UEs that arrive during the cell-DRX-off state (e.g., the off-duration of the cell-DRX cycle).

Cell-DRX and UE-DRX may be enabled, implemented, and/or configured separately. There is a need for systems and techniques that can be used to coordinate, configure, and/or control DTX and DRX implemented by various network entities. For example, there is a need for systems and techniques that can be used to align cell-DRX with UE-DRX. For example, when a cell-DRX cycle is aligned with one or more UE-DRX cycles, a base station can assign resources to other UEs to maximize or increase resource utilization by the base station. There is a further need for systems and techniques that can be used to align UE-DRX cycles with a corresponding cell-DTX cycle of a base station or gNB. There is a need for systems and techniques that can be used to implement UE-DRX configurations based on cell-DTX information.

Systems, apparatuses, processes (also referred to as methods), and computer-readable media (collectively referred to as “systems and techniques”) are described herein that can be used to perform discontinuous transmission (DTX) and discontinuous reception (DRX) between network entities. For example, the systems and techniques can be used to enable and/or disable a cell-DTX state (e.g., associated with a base station or gNB) based on a traffic load or quantity of active users (e.g., UEs) in the cell. In some cases, the systems and techniques can be used to enable and/or disable a cell-DRX state based on the traffic load or quantity of active users in the cell. The cell-DTX state may be aligned with the cell-DRX state.

In some examples, cell-DRX and cell-DTX can be dynamically enabled and disabled for a respective base station. One or more UEs may be associated with the respective base station. A corresponding UE DRX configuration associated with each UE of the one or more UEs can be adjusted based on the enabling and disabling of the cell-DRX and/or cell-DTX. For example, the one or more UEs can switch between UE-DRX configurations based on the cell-DRX/DTX enabled state of the corresponding base station associated with the one or more UEs.

In some cases, a UE can receive (e.g., from the base station) a first DRX configuration and a second DRX configuration. The first DRX configuration can be associated with a DTX-enabled state of the base station. The second DRX configuration can be associated with a DTX-disabled state of the base station. The second DRX configuration can be different from the first DRX configuration. For example, one or more DRX configuration parameter values of the second DRX configuration can be different from one or more DRX configuration parameter values of the first DRX configuration.

The UE can use the first DRX configuration information to implement UE-DRX associated with a DTX-enabled state of the base station. For example, the UE can use the first DRX configuration to align the UE-DRX on-duration with the cell-DTX on-duration of the base station. In some cases, the UE can use the first DRX configuration information to align the UE-DRX on-duration with the cell-DTX on-duration and the cell-DRX on-duration of the base station (e.g., the cell-DTX and cell-DRX on-durations may be aligned at the base station).

In some examples, the UE can use the second DRX configuration information to implement a second (e.g., different) UE-DRX on-duration when cell-DTX is disabled at the base station. For example, the base station can determine a respective second DRX configuration for each UE of a plurality of UEs (e.g., a plurality of UEs associated with the base station). Each respective second DRX configuration can be associated with a different starting time for implementing the respective UE-DRX on-duration at each UE. Based on the respective second DRX configuration associated with each UE, the UE-DRX on-duration and/or UE-DRX off-duration can be staggered or scattered across the different UEs.

In some cases, a UE can be configured with multiple sets of UE-DRX configuration parameter values. The UE can switch between the different UE-DRX configuration parameter values based on determining the cell-DTX/DRX has been enabled or disabled. In some cases, the UE can determine that cell-DTX/DRX has been enabled or disabled based on a dynamic signaling trigger. For example, the UE can receive a PHY or MAC signal (e.g., PDCCH, DCI, etc.) indicative of a cell-DTX-enabled or -disabled state and/or a cell-DRX-enabled or -disabled state. In some examples, the UE-DRX configurations can utilize a different UE-DRX on-duration start offset parameter for the cell-DTX enabled state and the cell-DTX disabled state. In some cases, one or more additional UE DRX configuration parameter values can differ between the first and second UE-DRX configurations, including a UE-DRX cycle parameter, a UE DRX on-duration timer, a UE-DRX inactivity timer, a DL and UL retransmission timer, a DL and UL round trip time (RTT) timer, etc.

In some examples, multiple radio resource control (RRC) UE-DRX configurations can be signaled to the UE (e.g., by the base station). Each RRC message or signal can be indicative of a different UE-DRX configuration. For example, a first RRC message can be indicative of the first UE-DRX configuration associated with the cell-DTX-enabled state of the base station and a second RRC message can be indicative of the second UE-DRX configuration associated with the cell-DTX-disabled state of the base station. In another example, a single RRC UE-DRX configuration can be received by the UE from the base station. The single RRC UE-DRX configuration signal can be indicative of one or more DRX configuration parameters. Each respective DRX configuration parameter of the one or more DRX configuration parameters can be associated with a first value, corresponding to the first UE-DRX configuration, and a second value, corresponding to the second UE-DRX configuration.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

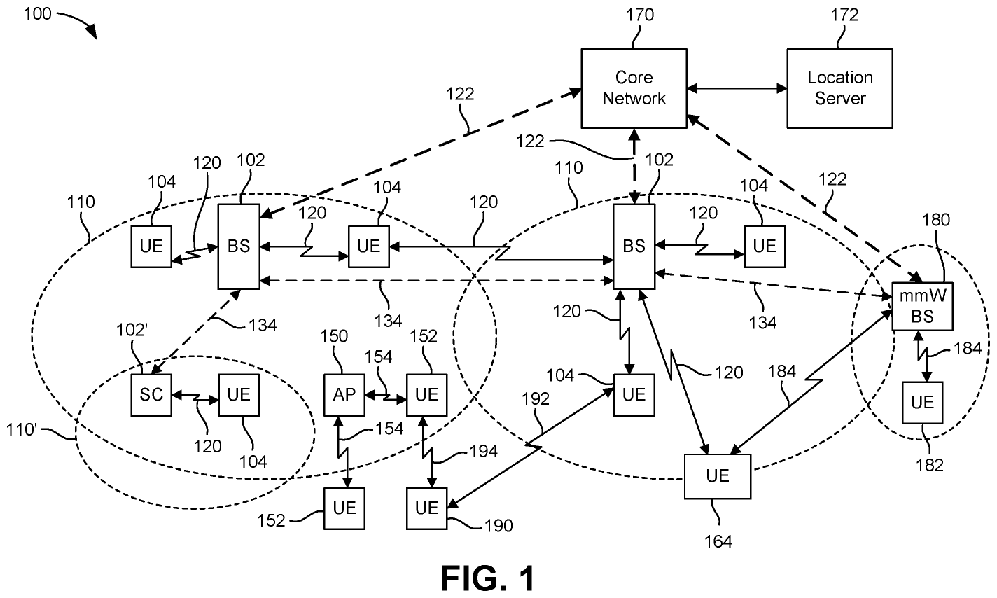

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHZ), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y’.

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

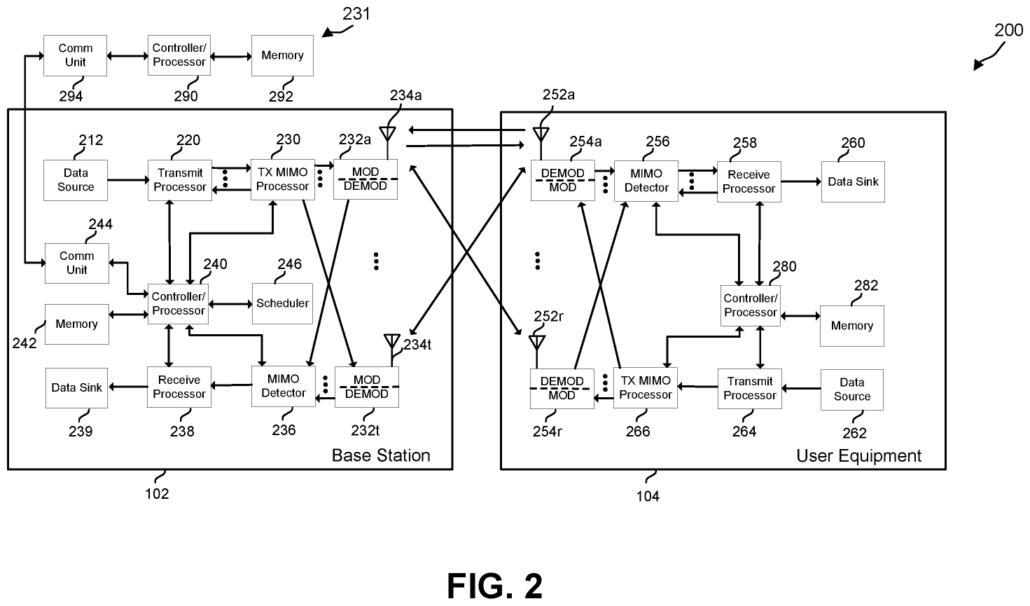

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

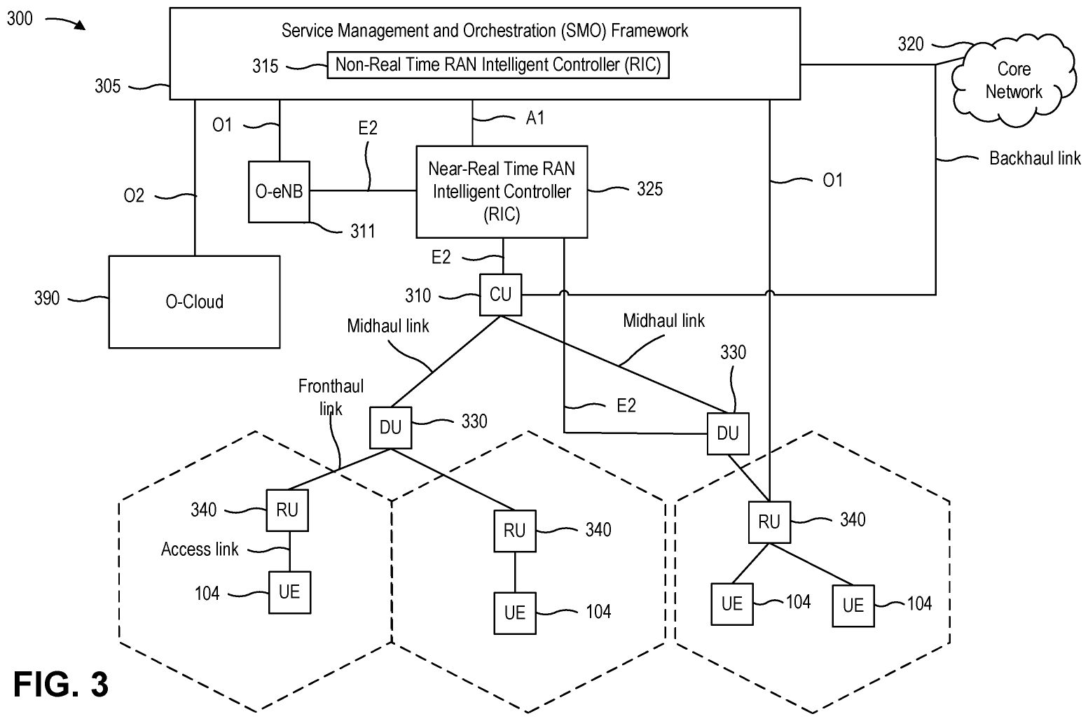

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

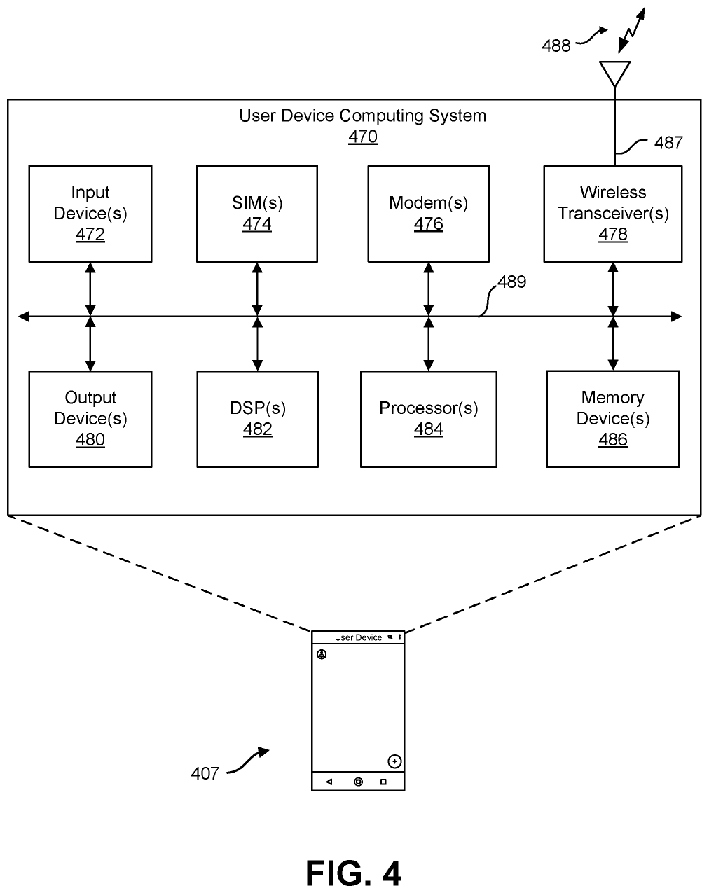

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICS, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

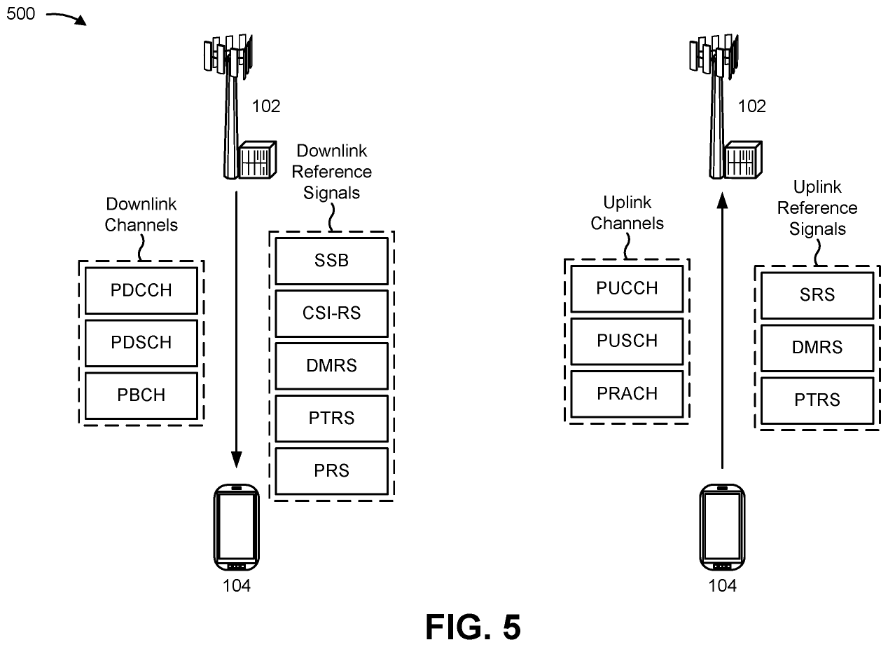

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

As mentioned previously, the systems and techniques described herein can be used to provide improved energy efficiency for wireless communications between UEs and base stations. In one illustrative example, the systems and techniques can provide dynamic implementation of UE-DRX configurations based on a DTX-enabled or disabled state of a base station or gNB (e.g., cell-DTX-enabled or -disabled state) and/or based on a DRX-enabled or disabled state of a base station or gNB (e.g., cell-DRX-enabled or -disabled state).

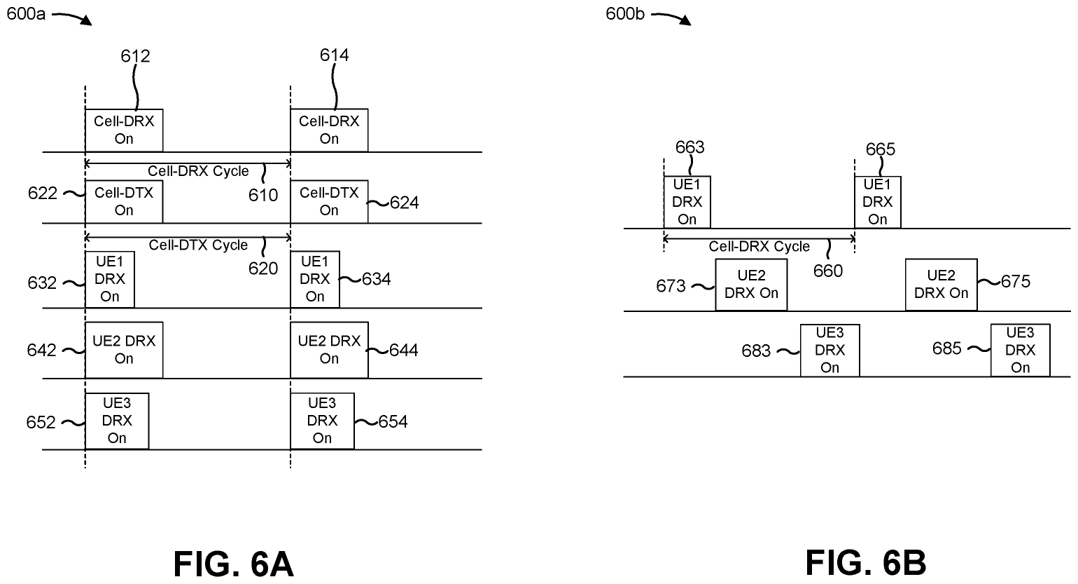

FIG. 6A is a diagram illustrating an example of aligned UE-DRX configurations 600a, in accordance with some examples. The aligned UE-DRX configurations 600a can correspond to a DTX-enabled state of a base station or gNB (e.g., cell-DTX-enabled) and/or a DRX-enabled state of the base station or gNB (e.g., cell-DRX-enabled). FIG. 6B is a diagram illustrating an example of non-aligned UE-DRX configurations 600b, in accordance with some examples. The non-aligned UE-DRX configurations 600b can correspond to a DTX-disabled state of the base station or gNB (e.g., cell-DTX-disabled) and/or a DRX-disabled state of the base station or gNB (e.g., cell-DRX-disabled).

As noted previously, UE-DRX configurations can be used to provide discontinuous reception of DL transmissions at a UE (e.g., discontinuous reception of DL transmissions from a base station by the UE). Similar to UE-DRX, cell-DRX configurations can be used to provide discontinuous reception of UE UL transmissions at the base station. For instance, when cell-DRX is enabled, the base station or gNB associated with a cell can monitor for UL transmissions from some (or all) of the UEs included in the cell.

In one illustrative example, when cell-DRX is enabled, the base station may monitor for UE UL transmissions periodically. For instance, the cell-DRX-enabled state can correspond to a cell-DRX cycle 610. The base station may monitor for UE UL transmissions for a portion of the cell-DRX cycle 610 (e.g., the cell-DRX on-duration 612, the cell-DRX on-duration 614, etc.). During the remainder of each cell-DRX cycle 610, the base station does not monitor for some (or all) UE UL transmissions. For example, the base station may still monitor for critical UL channels or signals (e.g., SRS). In some cases, the base station may monitor for critical UL channels or signals but with reduced density during the cell-DRX off-duration. For instance, a cell-DRX off-duration may be equal to the cell-DRX cycle 610 minus the cell-DRX on-duration 612 (e.g., during the cell-DRX cycle 610, the base station is in either a cell-DRX on-duration or a cell-DRX off-duration, with respect to the cell). In some aspects, the base station can enter a ‘sleep’ or ‘idle’ state during the cell-DRX off-duration of cell-DRX cycle 610. In some cases, the base station can enter the ‘sleep’ or ‘idle’ state with respect to a first cell (e.g., during the cell-DRX off-duration of the first cell), and may remain active or awake with respect to a second cell (e.g., to receive UE UL transmissions from UEs located in a second cell associated with the base station, during the cell-DRX on-duration of the second cell).

Successive cell-DRX on-durations 612 and 614 may be separated by the cell-DRX cycle time 610. Successive cell-DRX off-durations may additionally be separated by the cell-DRX cycle time 610. In some aspects, the cell-DRX on-duration and/or the cell-DRX off-duration may be the same across a plurality of cell-DRX cycles. In other examples, one or more (or both) of the cell-DRX on-duration and/or the cell-DRX off-duration may be different for various cycles of a plurality of cell-DRX cycles.

Cell-DTX configurations can be used to provide discontinuous transmission from the base station to one or more UEs in the cell. For example, a cell-DTX on-duration 622 can provide a periodic (e.g., discontinuous) time window, during which the base station can transmit DL transmissions to one or more UEs of the cell (e.g., and during which the UEs can receive DL transmissions from the base station). In one illustrative example, when cell-DTX is enabled, the base station can schedule any DL transmissions to UEs in the cell during the cell-DTX on-duration 622 of a cell-DTX cycle 620. During the remainder of each cell-DTX cycle 620, the base station does not transmit some (or all) DL transmissions to the one or more UEs of the cell. For example, the base station may still transmit critical DL channels or signals (e.g., SSB). In some cases, the base station may transmit critical DL channels or signals but with reduced density during the cell DRX-off-duration. For instance, a cell-DTX off-duration may be equal to the cell-DTX cycle 620 minus the cell-DTX on-duration 622 (e.g., during the cell-DTX cycle 620, the base station is in either a cell-DTX on-duration or a cell-DTX off-duration, with respect to the cell). In some aspects, the base station can enter a ‘sleep’ or ‘idle’ state during the cell-DTX off-duration of cell-DTX cycle 620. In some cases, the base station can enter the ‘sleep’ or ‘idle’ state with respect to a first cell (e.g., during the cell-DTX off-duration of the first cell), and may remain active or awake with respect to a second cell (e.g., to transmit DL transmissions to UEs located in a second cell associated with the base station, during the cell-DTX on-duration of the second cell).

Successive cell-DTX on-durations 622 and 624 may be separated by the cell-DTX cycle time 620. Successive cell-DTX off-durations may additionally be separated by the cell-DTX cycle time 620. In some aspects, the cell-DTX on-duration and/or the cell-DTX off-duration may be the same across a plurality of cell-DTX cycles. In other examples, one or more (or both) of the cell-DTX on-duration and/or the cell-DTX off-duration may be different for various cycles of a plurality of cell-DTX cycles.

In some aspects, the systems and techniques described herein can enable (and disable) cell-DRX and cell-DTX together. For example, enabling cell-DRX can be associated with enabling cell-DTX, and vice versa. In one illustrative example, a cell-DRX timeline (e.g., associated with cell-DRX cycle 610) can be aligned with a cell-DTX timeline (e.g., associated with cell-DTX cycle 620). In some cases, the alignment of cell-DRX and cell-DTX can be based on the tight coupling between UL and DL transmissions (e.g., PDSCH and HARQ-ACK report, PUSCH and potential UL re-transmission scheduling PDCCH, etc.).

In some examples, aligning the cell-DRX timeline and the cell-DTX timeline can be associated with aligning respective on-duration start times with one another. For instance, when the cell-DRX timeline is aligned with the cell-DTX timeline, a start time associated with cell-DRX on-duration 612 can be the same as a start time associated with the cell-DTX on-duration 622. In some examples, the respective start time can be determined relative to the beginning of the cell-DRX cycle 610 or cell-DTX cycle 620 in which the on-duration is respectively included. For example, the start time associated with cell-DRX on-duration 612 can be determined from or relative to the beginning of cell-DRX cycle 610, and the start time associated with cell-DTX on-duration 622 can be determined from or relative to the beginning of cell-DTX cycle 620.

In some examples, when the cell-DRX timeline is aligned with the cell-DTX timeline, an end time associated with cell-DRX on-duration 612 can be the same as an end time associated with cell-DTX on-duration 622. In some examples, the respective end time can be determined relative to the beginning of the cell-DRX cycle 610 or cell-DTX cycle 620 in which the on-duration is respectively included. For example, the end time associated with cell-DRX on-duration 612 can be determined from or relative to the beginning of cell-DRX cycle 610, and the end time associated with cell-DTX on-duration 612 can be determined from or relative to the beginning of cell-DTX cycle 620.

In some aspects, the cell-DRX on-duration 612 can be within the cell-DTX on-duration 622. For example, the cell-DTX on-duration 622 can include or be overlapping in time with the cell-DRX on-duration 612. In some cases, when cell-DRX on-duration 612 is within cell-DTX on-duration 622, the start time of cell-DRX on-duration 612 is the same as or later than a start time of cell-DTX on-duration 622, and the end time of cell-DRX on-duration 612 is the same as or before an end time of cell-DTX on-duration 622.

In one illustrative example, one or more UEs in the cell associated with cell-DRX cycle 610 and cell-DTX cycle 620 can obtain or receive information indicative of the cell-DTX of the serving base station or gNB (e.g., information indicative of cell-DTX parameters implemented by the base station or gNB associated with the cell). In some examples, a corresponding UE-DRX cycle of each respective UE of the one or more UEs associated with the cell can be aligned with at least the cell-DTX cycle 620. In examples where cell-DTX cycle 620 is aligned with cell-DRX cycle 610, the respective UE-DRX cycles may additionally be aligned with cell-DRX cycle 610.

For example, a first UE can be associated with a respective UE-DRX configuration for implementing a first UE-DRX on-duration 632. A second UE can be associated with a different UE-DRX configuration for implementing a second UE-DRX on-duration 642. A third UE can be associated with another UE-DRX configuration for implementing a third UE-DRX on-duration 652. In one illustrative example, the UE-DRX on-durations 632, 642, 652 can be aligned with one another (e.g., have a same on-duration start time, are fully overlapping in time, etc.).

The UE-DRX on-durations 632, 642, 652 may be of equal lengths and/or may be of different lengths. For example, as depicted in FIG. 6A, the first UE-DRX on-duration 632 is the shortest on-duration, the second UE-DRX on-duration 642 is the longest on-duration, and the third UE-DRX on-duration 652 is longer than the first UE-DRX on-duration 632 and shorter than the second UE-DRX on-duration 642.

In one illustrative example, the UE-DRX on-duration utilized by each respective UE can be aligned with at least the cell-DTX on-duration 622. For example, each of the UE-DRX on-durations 632, 642, 652 can be within the cell-DTX on-duration 622 (e.g., the respective start and end time of each UE-DRX on-duration can be within the start and end times of the cell-DTX on-duration 622). In some aspects, one or more (or all) of the UE-DRX on-durations 632, 642, 652 can be aligned with the cell-DTX on-duration 622 without sharing a same start time as the cell-DTX on-duration 622.

In some aspects, the UE-DRX on-duration utilized by each respective UE can be aligned with the cell-DTX on-duration based on each respective UE-DRX on-duration having a start time that is the same as or after than the start time of the cell-DTX on-duration. In this example, each respective UE does not wake up (e.g., exit the relatively low power ‘sleep’ or ‘idle’ state associated with the UE-DRX off-duration, outside of the UE-DRX on-duration) to attempt to receive any DL transmissions from the base station until at least the beginning of the cell-DTX on-duration in which the base station is configured to transmit DL transmissions. In one illustrative example, aligning the start time of each UE-DRX on-duration 632, 642, 652 with the start time of the cell-DTX on-duration 622 can be used to provide power savings at each UE.

For example, if a UE-DRX on-duration starts prior to the cell-DTX on-duration, the UE may waste power by unnecessarily monitoring PDCCH for indications of DL transmissions during the base station's cell-DTX off state (e.g., the cell-DTX off-duration during which no dynamically scheduled DL transmissions will be on the air from the base station to the UEs of the cell).

In some examples, the UE-DRX on-duration utilized by each respective UE can be aligned with the cell-DTX on-duration based on each respective UE-DRX on-duration having an end time that is the same as or before the end time of the cell-DTX on-duration. In this example, each respective UE does not remain awake and monitoring PDCCH for DL transmission indications during the base station's cell-DTX off state (e.g., the cell-DTX off-duration during which no dynamically scheduled DL transmissions will be on the air from the base station to the UEs of the cell)

In some aspects, a UE-DRX cycle time can be the same as one or more (or both) of the cell-DRX cycle time 610 and/or the cell-DTX cycle time 620. In some cases, the UE-DRX cycle time can be equal to a multiple of the cell-DRX cycle time 610 and/or the cell-DTX cycle time 620. For instance, when the UE-DRX cycle time is equal to a multiple of the cell-DTX cycle time, the UE-DRX on-duration will be aligned with a subset of the cell-DTX on-durations (e.g., if the UE-DRX cycle time is equal four times the cell-DTX cycle time, the UE-DRX on-duration will be aligned with every fourth cell-DTX on-duration). In some examples, the UE-DRX configuration for each respective UE of the cell can be the same across multiple consecutive UE-DRX cycles and cell-DTX cycles 620. For example, the first UE can receive one UE-DRX configuration corresponding to the cell-DTX enabled state and/or the cell-DRX enabled state of the base station, and may use the one UE-DRX configuration to implement a UE-DRX on-duration 632 (e.g., corresponding to the first cell-DTX cycle with cell-DTX on-duration 622) that is the same as a later UE-DRX on-duration 634 (e.g., corresponding to the second cell-DTX cycle with cell-DTX on-duration 624).

The second UE can receive one UE-DRX configuration corresponding to the cell-DTX enabled state and/or the cell-DRX enabled state of the base station, and may use the one UE-DRX configuration to implement a UE-DRX on-duration 642 (e.g., corresponding to the first cell-DTX cycle with cell-DTX on-duration 622) that is the same as a later UE-DRX on-duration 644 (e.g., corresponding to the second cell-DTX cycle with cell-DTX on-duration 624). The third UE can receive one UE-DRX configuration corresponding to the cell-DTX enabled state and/or the cell-DRX enabled state of the base station, and may use the one UE-DRX configuration to implement a UE-DRX on-duration 652 (e.g., corresponding to the first cell-DTX cycle with cell-DTX on-duration 622) that is the same as a later UE-DRX on-duration 654 (e.g., corresponding to the second cell-DTX cycle with cell-DTX on-duration 624).

As will be described in greater depth below, each UE of the cell can receive one or more UE-DRX configurations from the serving base station or gNB associated with the cell and/or associated with the one or more UEs of the cell. In some aspects, each UE of the cell can receive or otherwise determine a respective first UE-DRX configuration that is associated with the DTX-enabled state of the base station. The respective first UE-DRX configuration can be used to implement a UE-DRX on-duration that is within the cell-DTX on-duration of each cell-DTX cycle.

Each UE of the cell can additionally receive or otherwise determine a respective second UE-DRX configuration that is associated with a DTX-disabled state of the base station. The respective second UE-DRX configuration can be used to implement a UE-DRX on-duration that is offset or staggered relative to the remaining UE-DRX on-durations of UEs in the cell, as will be described below with respect to FIG. 6B. In some cases, the respective second UE-DRX configuration can be implemented based on determining that cell-DTX is disabled (e.g., is not enabled) for the serving base station or gNB of the UE's cell.

In some examples, cell-DRX and cell-DTX can be dynamically enabled and disabled for a respective base station and/or for particular cells served by the respective base station. For example, cell-DRX and cell-DTX can be enabled or disabled based on analyzing an overall traffic load of the particular cell. In some aspects, cell-DTX and/or cell-DRX may be implemented based on determining a relatively low traffic load for the particular cell and/or based on determining a relatively low quantity of active UEs in the cell. In some examples, based on determining a relatively high traffic load for the cell, cell-DTX and/or cell-DRX may be disabled. In some aspects, by enabling or disabling cell-DTX and cell-DRX based on a traffic load and/or quantity of active users associated with the cell, the systems and techniques can be used to implement dynamic power saving to maximize the network energy saving gain.

In one illustrative example, UE-DRX may be enabled during the cell-DTX/-DRX enabled state (e.g., corresponding to the example of FIG. 6A) and during the cell-DTX/-DRX disabled state (e.g., corresponding to the example of FIG. 6B). The UE-DRX configurations corresponding to the cell-DTX enabled state can be indicative of UE-DRX configuration parameter values that correspond to respective UE-DRX on-durations that are aligned with (e.g., within) the cell-DTX on-duration. The UE-DRX configurations corresponding to the cell-DTX disabled state can be indicative of UE-DRX configuration parameter values that correspond to respective UE-DRX on-durations that are not aligned with one another (e.g., the respective UE-DRX on-durations of the one or more UEs of the cell can be staggered based on determining a cell-DTX disabled state). In some examples, staggering the UE-DRX on-durations during the cell-DTX disabled state can be used to maximize opportunities for multi-user scheduling while saving UE power consumption.

In some aspects, a corresponding UE-DRX configuration associated with each UE of the particular cell can be adjusted based on determining an enabled or disabled state of the cell-DTX and/or cell-DRX at the serving base station of the particular cell. The first UE-DRX configuration (e.g., associated with the cell-DTX enabled state) and the second UE-DRX configuration (e.g., associated with the cell-DTX disabled state) can each include one or more DRX configuration parameter values. One or more (or all) of the DRX configuration parameter values can be different between the first DRX configuration (e.g., used to configure UE-DRX during a cell-DTX enabled state) and the second DRX configuration (e.g., used to configure UE-DRX during a cell-DTX disabled state).

In one illustrative example, the DRX configuration parameter values can include at least an on-duration start offset indicative of a time offset between the start of a cycle (e.g., the start of a UE-DRX cycle, the start of a cell-DTX cycle, the start of a cell-DRX cycle, etc.) and the start of each respective UE-DRX on-duration. For example, the first UE-DRX configuration (e.g., associated with the cell-DTX enabled state) for each UE of the cell can be indicative of an on-duration start offset that is the same or similar for each UE, where each respective on-duration start offset implements a respective UE-DRX on-duration that is within the cell-DTX on-duration.

The second UE-DRX configuration (e.g., associated with the cell-DTX disabled state) for each UE of the cell can be indicative of an on-duration start offset that is different for each UE, where each respective on-duration start offset implements a respective UE-DRX on-duration that is non-overlapping or partially overlapping with the remaining UE-DRX on-durations of the UEs of the cell.

For example, FIG. 6B is a diagram illustrating an example of non-aligned UE-DRX configurations 600b, in accordance with some examples. The UE1, UE2, and UE3 of FIG. 6B can be the same as or similar to the UE1, UE2, and UE3 of FIG. 6A. In some aspects, each UE can be associated with the same UE-DRX cycle 660 (e.g., each UE implements its corresponding cell-DTX disabled UE-DRX configuration using the same UE-DRX cycle 660). In one illustrative example, each UE of the cell can be configured with a different UE-DRX configuration, where each UE-DRX on-duration is associated with a different portion of the UE-DRX cycle 660 and is non-overlapping in time with the remaining UE-DRX on-durations.

For instance, during each UE-DRX cycle 660 while the cell-DTX is in the disabled state, UE1 can implement a UE-DRX on-duration 663 at the beginning of the UE-DRX cycle 660. In some examples, a start time of the UE1 DRX on-duration 663 can be the same as or similar to the start time of the UE-DRX cycle 660. After the end time of the UE1 DRX on-duration 663 (or simultaneously with the end time of UE1 DRX on-duration 663) is the start time of the UE2 UE-DRX on-duration 673. UE2 DRX on-duration 673 can be non-overlapping in time with UE1 DRX on-duration 673 (e.g., staggered). The third UE, UE3, can implement a UE3 DRX on-duration 683 that has a start time the same as or after the end time of UE2 DRX on-duration 673. UE3 DRX on-duration 683 and UE2 DRX on-duration 673 can be non-overlapping in time (e.g., staggered).

In some aspects, the staggered scheduling of the different UE DRX on-durations for the UEs of the cell (e.g., UE1, UE2, UE3) can be the same for each repetition of UE-DRX cycle 660. For instance, the UE1 DRX on-duration 665 (and associated on-duration start offset relative to the beginning of the second UE-DRX cycle) can be the same as the UE1 DRX on-duration 663 and the associated on-duration start offset relative to the beginning of the first UE-DRX cycle 660. The UE2 DRX on-duration 675 (and associated on-duration start offset relative to the beginning of the second UE-DRX cycle) can be the same as the UE2 DRX on-duration 673 and the associated on-duration start offset relative to the beginning of the first UE-DRX cycle 660. The UE3 DRX on-duration 685 (and associated on-duration start offset relative to the beginning of the second UE-DRX cycle) can be the same as the UE3 DRX on-duration 683 and the associated on-duration start offset relative to the beginning of the first UE-DRX cycle 660.

In some cases, the DRX configuration parameter values can additionally include one or more (or all) of a UE-DRX cycle value, an on-duration timer value, an inactivity timer value, a DL retransmission timer value, an UL retransmission timer value, a DL RTT timer value, an UL RTT timer value, etc.

In one illustrative example, a UE can be configured with multiple sets of UE-DRX configuration parameter values. Based on a determination and/or signal that cell-DTX and cell-DRX have been enabled or disabled, the UE can switch from using a first set of UE-DRX configuration parameters corresponding to the cell-DTX (and cell-DRX) enabled state to using a second set of UE-DRX configuration parameters corresponding to the cell-DTX (and cell-DRX) disabled state.

In some aspects, each UE of one or more UEs associated with a particular cell (e.g., and a serving base station or gNB of the particular cell) can be configured with first and second sets of UE-DRX configuration parameter values by the serving base station or gNB. For instance, a serving base station or gNB associated with a cell that includes at least UE1, UE2 and UE3 can be used to configure each UE with a respective first UE-DRX configuration (e.g., corresponding to the cell-DTX enabled state and the UE-DRX configurations of FIG. 6A) and a respective second UE-DRX configuration (e.g., corresponding to the cell-DTX disabled state and the UE-DRX configurations of FIG. 6B).

In one illustrative example, the enabling and/or disabling of cell-DTX and cell-RTX at the serving base station or gNB of the cell associated with a UE can be triggered based on dynamic signaling. For instance, the base station can signal or indicate to the UEs of a cell when cell-DTX and cell-RTX are enabled, disabled, and/or change state. In some aspects, the dynamic signaling of a cell-DTX enabled or disabled state can be based on one or more PHY signals (e.g., PDCCH, DCI, etc.) transmitted by the serving base station or gNB and received by the one or more UEs of the cell. In another example, the dynamic signaling of a cell-DTX enabled or disabled state can be based on one or more MAC signals transmitted by the serving base station or gNB and received by the one or more UEs of the cell. In some cases, the cell-DTX enabled or disabled state can be indicated to the one or more UEs of the cell based on a PDCCH, DCI, and/or MAC-CE, among various others.

In some aspects, a UE can determine a DTX-enabled state and/or a DTX-disabled state of a serving base station or gNB associated with the UE's cell based on one or more timer values. For example, the UE can determine the DTX-enabled state of the base station based on receipt or non-receipt of a signal relative to a period of time. In some cases, the signal can be a particular broadcast signal from the base station. In some examples, the expected signal and/or the period of time can be configured for the base station and each of the one or more UEs of a cell served by the base station. In some examples, the UE can determine the DTX enabled state of the base station based on non-receipt of the signal relative to the period of time (e.g., a timer interval). In some examples, the UE can determine the DTX disabled state of the base station based on receipt of the signal relative to the period of time (e.g., the timer interval). In some cases, the same period of time (e.g., timer interval) can be used for determining the DTX enabled state and the DTX disabled state based on non-receipt or receipt of the signal relative to the period of time, respectively. In some examples, a different period of time (e.g., timer interval) can be used for determining the DTX enabled state based on non-receipt of the signal relative to a first period of time or determining the DTX disabled state based on receipt of the signal relative to a second period of time.

In some cases, cell-DTX can be enabled and disabled separately (e.g., independently) from enabling and disabling cell-DRX. Separate signaling can be used to indicate to the one or more UEs when cell-DTX is enabled or disabled, and when cell-DRX is enabled or disabled. In some aspects, cell-DTX and cell-DRX can be enabled and disabled together (e.g., such as when the cell-DTX timeline is aligned with the cell-DRX timeline, as described previously above).

In one illustrative example, the first DRX configuration for a UE (e.g., corresponding to the DTX enabled state of the serving base station or gNB) can differ from the second DRX configuration for the UE (e.g., corresponding to the DTX disabled state of the serving base station or gNB) by at least the value of the UE-DRX on-duration start offset parameter. As noted above, the UE-DRX on-duration start offset parameter can be indicative of an offset (e.g., time delay or time difference) between the start of the UE-DRX cycle and the start of the DRX on-duration for a particular UE. In some examples, the UE-DRX on-duration start offset parameter can correspond to a drx-LongCycleStartOffset parameter).

In some cases, the first DRX configuration for a UE can differ from the second DRX configuration for the UE by at least the value of the UE-DRX on-duration start offset parameter and one or more additional DRX configuration parameter values. For instance, the one or more additional DRX configuration parameter values that are different between the first and second DRX configurations for a UE can include a DRX on-duration (e.g., corresponding to a drx-onDurationTimer parameter), a DRX cycle duration (e.g., corresponding to the drx-LongCycleStartOffset parameter), a DRX inactivity timer (e.g., corresponding to a drx-InactivityTimer parameter), a DL retransmission timer (e.g., corresponding to a drx-RetransmissionTimerDL), an UL retransmission timer (e.g., corresponding to a drx-RetransmissionTimerUL), a DL round trip time (RTT) timer (e.g., corresponding to a drx-HARQ-RTT-TimerDL parameter), and/or an UL RTT timer (e.g., corresponding to a drx-HARQ-RTT-TimerUL parameter).

In some aspects, the different UE-DRX configuration parameter values (e.g., the first DRX configuration corresponding to the cell-DTX enabled state, and the second DRX configuration corresponding to the cell-DTX disabled state) can be indicated using multiple transmissions or signals from the serving base station or gNB to the one or more UEs of a particular cell. For example, multiple RRC UE-DRX configurations can be provided to a UE with different values for at least the UE-DRX on-duration start offset parameter. For instance, a first RRC UE-DRX configuration can be indicative of the first DRX configuration for a particular UE, where the particular UE implements the first DRX configuration based on determining a DTX enabled state of the serving base station or gNB. A second RRC UE-DRX configuration can be indicative of the second DRX configuration for the particular UE, where the particular UE implements the second DRX configuration based on determining a DTX disabled state of the serving base station or gNB (and/or based on failing to determine a DTX enabled state of the serving base station or gNB).

In another example, the same RRC UE-DRX configuration for a particular UE can be configured with multiple values for each DRX configuration parameter that differs between the first and second DRX configurations. For example, the single RRC UE-DRX configuration can include a first on-duration start offset value corresponding to the first DRX configuration and can include a second on-duration start offset value corresponding to the second DRX configuration. DRX configuration parameters that are the same between the first and second DRX configurations can be represented using a single value in the single RRC UE-DRX configuration. For instance, if a particular UE utilizes the same UE-DRX cycle length for both the first and second DRX configuration parameters, the single RRC UE-DRX configuration can include only one value for the UE-DRX cycle length parameter. In some cases, a secondary DRX group may be configured for UE-DRX. A secondary DRX group can share the same on-duration start offset parameter value with the primary DRX group. Remaining DRX parameters may vary between the primary DRX group and the secondary DRX group. The different DRX configurations (and associated parameters) for primary and secondary DRX groups can be indicated by the base station to the UE using separate transmissions (e.g., separate RRC UE-DRX configurations for the primary and secondary DRX groups) and/or can be indicated using a single transmissions (e.g., one single RRC UE-DRX configuration including first and second values for DRX configuration parameters that differ between the primary and secondary DRX groups).

In another illustrative example, a UE can receive (e.g., from the serving base station or gNB), information indicative of a DRX configuration for the UE associated with the DTX disabled state of the base station. For instance, the UE can receive the cell-DTX-disabled state UE-DRX configuration parameters in a manner the same as or similar to that described above with respect to the second DRX configuration.

The UE can obtain the cell-DTX-enabled state UE-DRX configuration parameters (e.g., the first DRX configuration described above) by overriding one or more DRX configuration parameter values of the cell-DTX disabled UE-DRX configuration. For example, the UE can override one or more DRX configuration parameter values for the cell-DTX disabled UE-DRX configuration using corresponding parameter values in one or more (or both) of the cell-DTX configuration implemented by the base station and/or the cell-DRX configuration implemented by the base station. In some aspects, the cell-DTX configuration and/or the cell-DRX configuration implemented by the base station can be signaled to the UE by the base station or may otherwise be available at the UE based on registering or communicating with the serving base station or gNB associated with the UE's cell.

For example, the override can be performed based on one or more configuration parameters being the same between the cell-DTX configuration, the cell-DRX configuration, and the UE-DRX configuration during the cell-DTX enabled state (e.g., as depicted in FIG. 6A). The shared configuration parameters between the cell-DTX/-DRX configuration and the UE-DRX configuration can include at least the on-duration start offset and the DRX cycle. For instance, when cell-DTX is enabled, the UE-DRX configuration can be aligned with (e.g., within) the cell-DTX on-duration, and the cell-DTX cycle 620 can be the same as the UE-DRX cycle for each UE of the cell. Based on the cell-DTX cycle 620 being the same as the UE-DRX cycle, the cell-DTX cycle 620 and UE-DRX cycles have the same start time.

In some cases, UE-DRX can be implemented based on PDCCH monitoring for dynamic grant scheduling or triggering (e.g., corresponding to or indicative of one or more DL transmissions from the serving base station or gNB to the UE). In some examples, a UE may perform autonomous transmission and/or reception that is not dynamically scheduled or triggered by PDCCH. In one illustrative example, the systems and techniques can be used to align the autonomous UE transmission(s) and/or reception(s) with the cell-DTX and cell-DRX. For example, aligning a periodicity associated with the autonomous UE transmission(s) and/or reception(s) with a periodicity associated with the cell-DTX and cell-DRX can improve power efficiency of the UEs and network. In some cases, when cell-DTX and cell-DRX are enabled, a density of signals and/or quantity of channels associated with the autonomous UE transmission(s) and/or reception(s) can be reduced. Based on reducing the signal density and/or channel quantity, the serving base station or gNB can reduce the blind detections for potential UE UL transmissions. Additionally, the one or more UEs of a cell can reduce a respective power consumption based on a reduction in transmissions from the serving base station or gNB.

In another illustrative example, a UE can switch between different UE-DRX configurations based on the cell-DTX and cell-DRX enabled or disabled state of the serving base station or gNB (e.g., as described above), and may additionally switch between different UE configurations based on a channel and/or signal type associated with communications between the UE and the serving base station or gNB. For instance, different UE-DRX configurations can be provided for one or more (or all) of configured grant PUSCH, semi-persistent scheduled PDSCH, search space set (SSS) or SSS group for PDCCH monitoring, PUCCH resource, scheduling request, random access resource, active bandwidth part (BWP), etc.

In some cases, the systems and techniques described herein can be used to implement UE configurations for one or more UEs that are implementing or running an extended reality (XR) application or service. In some examples, XR applications or services can be associated with both high peak throughput and low latency service requirements (e.g., service requirements from the serving base station or gNB). In one illustrative example, the systems and techniques can be used to maintain service continuity for XR UEs as the serving base station or gNB enables and disables cell-DTX and/or cell-DRX for the cell of the XR UE(s). For instance, cell-DTX and cell-DRX may be enabled and disabled without interruption to services for XR UEs and/or XR users.

In some cases, even a single XR user may consume a major portion of available resources in a cell. When the traffic load in the cell is not low (e.g., is relatively high), the quantity of active users in the cell may be relatively small if some of the users have high throughput (e.g., are XR users). In one illustrative example, the systems and techniques can maintain service continuity for XR users based on implementing cell-DRX/-DTX enabling and disabling to be transparent to XR users and XR services. For instance, the systems and techniques can maintain service continuity for XR users by configuring the cell-DTX cycle and the cell-DRX cycle to be aligned with an XR traffic periodicity.

In one illustrative example, the cell-DTX and cell-DRX cycle of a serving base station or gNB associated with one or more XR UEs, XR users, and/or XR services, etc., can be aligned with the non-integer periodicity of XR traffic. For example, the non-integer periodicity of XR traffic can correspond to the XR video generation rate. In some aspects, a 30 frames-per-second (fps) XR video generation rate can correspond to a 33.33 ms periodicity. A 60 fps XR video generation rate can correspond to a 16.66 ms periodicity. A 120 fps XR video generation rate can correspond to an 8.33 ms periodicity. In some aspects, a single cell-DTX cycle or a single cell-DRX cycle can be configured for all XR users of the cell based on the highest video generation rate among the XR users of the cell (e.g., in examples where the XR users of a cell have different XR video generation rates).

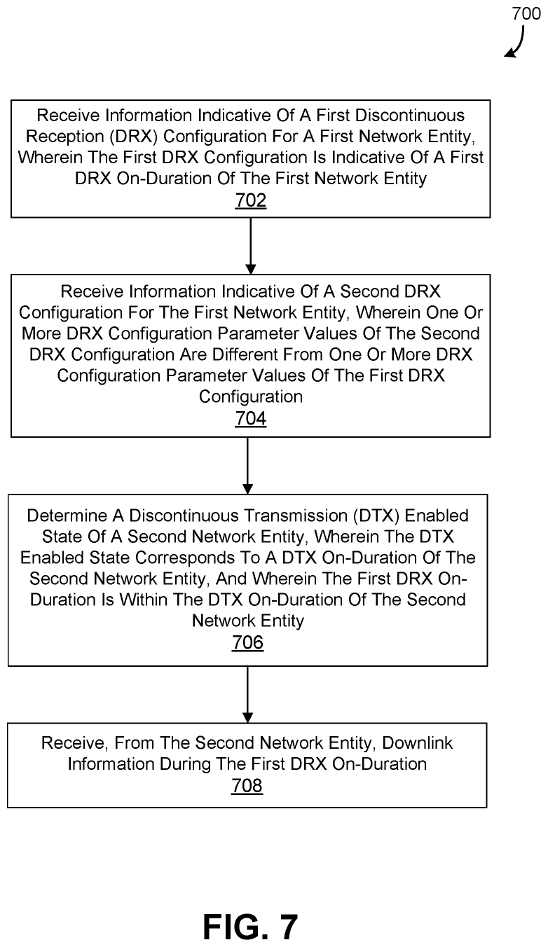

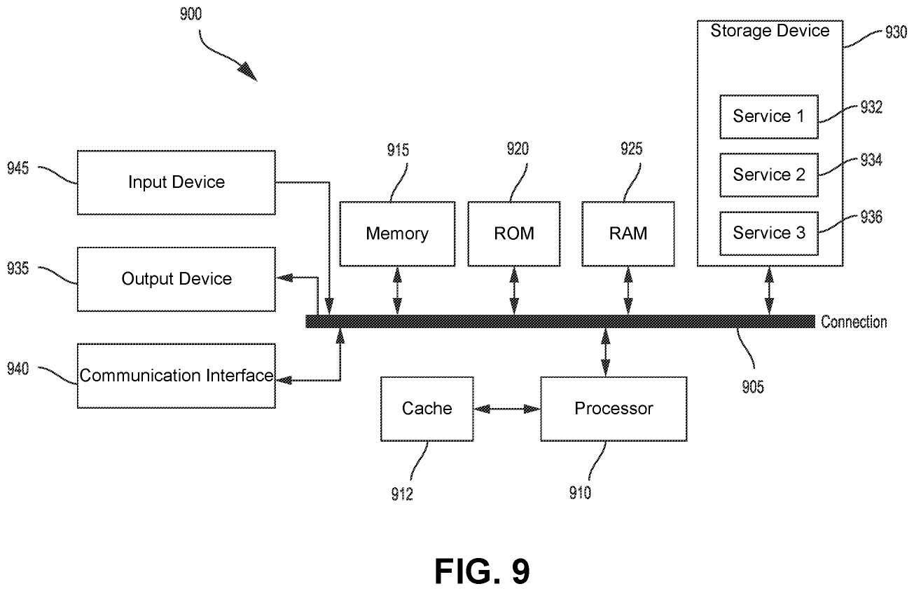

FIG. 7 is a flowchart diagram illustrating an example of a process 700 for wireless communications. The process 700 may be performed by a first network entity or by a component or system (e.g., a chipset) of the first network entity. The first network entity may be a UE (e.g., a mobile device such as a mobile phone, a network-connected wearable such as a watch, an extended reality device such as a virtual reality (VR) device or augmented reality (AR) device, a vehicle or component or system of a vehicle, or other type of UE) or other type of network entity. In some examples, the first network entity can be a UE that is the same as or similar to one or more of the UEs of any of FIG. 1, FIG. 2, FIG. 3, FIG. 4, etc. The operations of the process 700 may be implemented as software components that are executed and run on one or more processors (e.g., processor 910 of FIG. 9 or other processor(s)). Further, the transmission and reception of signals by the wireless communications device in the process 700 may be enabled, for example, by one or more antennas and/or one or more transceivers (e.g., antenna(s) and/or wireless transceiver(s) of any of FIG. 2, FIG. 4, FIG. 9, etc.).

At block 702, the first network entity (or component thereof) may receive information indicative of a first discontinuous reception (DRX) configuration for the first network entity, wherein the first DRX configuration is indicative of a first DRX on-duration of the first network entity. For example, the first network entity can be the same as or similar to one or more of the UEs 104 of FIG. 1, the UE 104 of FIG. 2, the UEs 104 of FIG. 3, and/or the user device computing system 470 of FIG. 4. In some cases, the first DRX on-duration of the first network entity can be the same as or similar to one or more of the UE DRX on-durations 632, 642, 652 (and/or the UE DRX On-durations 634, 644, 654) of FIG. 6A. In some examples, the first DRXC configuration is associated with a discontinuous transmission (DTX) enabled state of a second network entity. For example, the second network entity can be a base station, gNB, etc., and may be the same as or similar to one or more of the base stations 102, 180 of FIG. 1, the base station 102 of FIG. 2, etc.

In some cases, the first DRX configuration includes a first plurality of values, wherein each value of the first plurality of values corresponds to a respective DRX configuration parameter of a plurality of DRX configuration parameters. For example, the plurality of DRX configuration parameters can include one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.

In some cases, to receive information indicative of the first DRX configuration, the first network entity (or component thereof) may receive, from a second network entity (e.g., base station, gNB, etc.) a first Radio Resource Control (RRC) signal including the information indicative of the first DRX configuration.

In some cases, to receive the information indicative of the first DRX configuration, the first network entity (or component thereof), may receive configuration information associated with the second network entity (e.g., base station, gNB, etc.), wherein the configuration information includes the information indicative of the first DRX configuration. For instance, the first DRX configuration of the first network entity (e.g., UE) can be associated with the DTX enabled state of the second network entity (e.g., base station, gNB, etc.) In some cases, the first DRX configuration of the first network entity can be the same as or similar to a DTX configuration of the second network entity.

In some examples, the first DRX on-duration is overlapping in time with at least a portion of a respective DRX on-duration associated with each UE of a plurality of UEs, the first network entity included in the plurality of UEs. For example, the first DRX on-duration can be the same as or similar to the UE1 DRX on-duration 632 of FIG. 6A, which is overlapping in time with at least a portion of the respective DRX on-durations 642, 652 associated with a UE2 and UE3, respectively.

In some cases, the first DRX on-duration and the respective DRX on-duration associated with each UE of the plurality of UEs are within the DTX on-duration of the second network entity. For example, the first DRX on-duration 632 and the respective DRX on-durations 642 and 652 are each within the cell-DTX on-duration 622 of FIG. 6A. In some examples, the first DRX configuration can be indicative of a DRX cycle duration, wherein the DRX cycle duration is the same as a DTX cycle duration associated with the DTX enabled state. For example, the DRX cycle duration can be the same as the DTX cycle duration of cell-DTX cycle 620 of FIG. 6A.

In some examples, the first DRX configuration is indicative of a first DRX on-duration start offset associated with the first network entity. The first DRX on-duration start offset can be the same as a respective DRX on-duration start offset associated with each UE of the plurality of UEs. For example, each of the UE-DRX on-durations 632, 642, 652 of FIG. 6A are associated with a same DRX on-duration start offset. In some examples, the first DRX on-duration start offset is a time offset from a beginning of a DTX cycle associated with the DTX enabled state of the second network entity (e.g., base station, gNB, etc.). For instance, the DTX cycle associated with the DTX enabled state can be the same as or similar to the cell-DTX cycle 620 of FIG. 6A.

At block 704, the first network entity (or component thereof) may receive information indicative of a second DRX configuration for the first network entity, wherein one or more DRX configuration parameter values of the second DRX configuration are different from one or more DRX configuration parameter values of the first DRX configuration. In some examples, the first DRX configuration is associated with the DTX enabled state of the second network entity (e.g., base station, gNB, etc.), and the second DRX configuration is associated with a DTX disabled state of the second network entity.

In some cases, the first DRX configuration is received based on receiving, from the second network entity, a first RRC signal including the information indicative of the first DRX configuration. The second DRX configuration can be received based on receiving, from the second network entity, a second RRC signal including the information indicative of the second DRX configuration. The second RRC signal is different from the first RRC signal.

In some examples, receiving the information indicative of the first DRX configuration and receiving the information indicative of the second DRX configuration comprises receiving, from the second network entity, a RRC signal including the information indicative of the first DRX configuration and including the information indicative of the second DRX configuration. In some cases, the RRC signal is indicative of one or more DRX configuration parameters, wherein each respective DRX configuration parameter of the one or more DRX configuration parameters is associated with a first value corresponding to the first DRX configuration and a second value corresponding to the second DRX configuration.

In some examples, to receive the information indicative of the first DRX configuration, the first network entity (or component thereof) is configured to receive configuration information associated with the second network entity. For example, the first network entity can receive a DTX configuration information of the second network entity, wherein the DTX configuration includes information indicative of the first DRX configuration. For example, the first DRX configuration can be the same as or otherwise based on one or more parameters of the DTX configuration corresponding to the DTX enabled state of the second network entity.

In some aspects, a DRX on-duration start offset parameter value included in the second DRX configuration can be replaced with a respective on-duration start offset parameter value included in the configuration information associated with the network entity. In some cases, a DRX cycle duration parameter value included in the second DRX configuration can be replaced with a respective cycle duration parameter value included in the configuration information associated with the second network entity. In some cases, the configuration information associated with the second network entity includes one or more of a DRX configuration associated with the second network entity or a DTX configuration associated with the second network entity.

In some cases, the first DRX configuration includes a first plurality of values, wherein each value of the first plurality of values corresponds to a respective DRX configuration parameter of a plurality of DRX configuration parameters. The second DRX configuration can include a second plurality of values, wherein each value of the second plurality of values corresponds to a respective DRX configuration parameter of the plurality of DRX configuration parameters. In some examples, at least one value of the second plurality of values corresponds to a particular DRX configuration parameter and is different from at least one value of the first plurality of values corresponding to the particular DRX configuration parameter. For instance, the particular DRX configuration parameter can include one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.

At block 706, the first network entity (or component thereof) may determine a discontinuous transmission (DTX) enabled state of the second network entity, wherein the DTX enabled state corresponds to a DTX on-duration of the second network entity, and wherein the first DRX on-duration is within the DTX on-duration of the second network entity. For example, the DTX enabled state can correspond to the DTX on-duration 622 of FIG. 6A. The first DRX on-duration can be the same as or similar to the UE1 DRX on-duration 632 of FIG. 6A, which is within the DTX on-duration 622 of FIG. 6A.

In some examples, the DTX enabled state is aligned with a DRX enabled state of the second network entity, based on a periodicity of the DTX enabled state being a multiple of a periodicity of a DRX enabled state of the second network entity or a periodicity of the DRX enabled state being a multiple of a periodicity of a DTX enabled state of the second network entity. For example, the DTX enabled state 622 of FIG. 6A can be aligned with the DRX enabled state 612 of FIG. 6A. The periodicity of the DTX enabled state can be the same as or similar to the Cell-DTX cycle 620 and the periodicity of the DRX enabled state can be the same as or similar to the Cell-DRX cycle 610. In some cases, at least a portion of the DTX on-duration corresponding to the DTX enabled state (e.g., the cell-DTX on-duration 622) can overlap with at least a portion of a DRX on-duration corresponding to the DRX enabled state (e.g., the cell-DRX on-duration 612).

In some cases, the periodicity of the DTX enabled state is the same as the periodicity of the DRX enabled state. In some examples, the DTX enabled state is aligned with the DRX enabled state based on a DTX on-duration start offset associated with the periodicity of the DTX enabled state being the same as a DRX on-duration start offset associated with the periodicity of the DRX enabled state.

In some aspects, to determine the DTX enabled state of the second network entity, the first network entity (or component thereof) is configured to receive, from the second network entity, information indicative of the DTX enabled state of the second network entity. In some examples, the first network entity (or component thereof) can determine the DTX enabled state of the second network entity based on receipt or non-receipt of a signal relative to a period of time. For instance, the first network entity can determine the DTX enabled state of the second network entity based on non-receipt of the signal relative to the period of time, and can determine a DTX disabled state of the second network entity based on receipt of the signal relative to the period of time.

In some cases, the second DRX configuration is indicative of a second DRX on-duration of the first network entity and is associated with a DTX disabled state of the second network entity. The second DRX on-duration can be non-overlapping in time with a respective DRX on-duration associated with each user equipment (UE) of a plurality of UEs. For example, the second DRX on-duration can be the same as or similar to the UE1 DRX on-duration 663 of FIG. 6B, which is non-overlapping in time with the respective DRX on-durations 672 and 683 associated with a UE2 and UE3, respectively. In some cases, the first network entity (or component thereof) can be configured to receive, from the second network entity, downlink information during the second DRX on-duration. In some examples, the respective DRX on-duration associated with each UE of the plurality of UEs and the second DRX on-duration are associated with a same DRX cycle duration. For instance, the UE1 DRX on-duration 663, the UE2 DRX on-duration 673, and the UE 3 DRX on-duration 683 of FIG. 6B can each be associated with the same DRX cycle duration of the cell-DRX cycle 660.

In some cases, the second DRX configuration is indicative of a second DRX on-duration start offset associated with the first network entity, wherein the second DRX on-duration start offset is different from a respective DRX on-duration start offset associated with each UE of the plurality of UEs. For example, the UE1 DRX on-duration 663, the UE2 DRX on-duration 673, and the UE 3 DRX on-duration 683 of FIG. 6B can each be associated with a different respective DRX on-duration start offset. The offset can be a time offset relative to the DRX cycle 660.

At block 708, the first network entity (or component thereof) may receive, from the second network entity, downlink information during the first DRX on-duration. In some cases, the first DRX configuration is associated with the DTX enabled state of the second network entity and a channel type associated with the downlink information. For example, the channel type associated with the downlink information can be a configured grant Physical Uplink Shared Channel (PUSCH), a semi-persistent scheduled Physical Downlink Shared Channel (PDSCH), a Search Space Set (SSS), or an SSS group for Physical Downlink Control Channel (PDCCH) monitoring. In some cases, the channel type associated with the downlink information is associated with a Physical Uplink Control Channel (PUCCH) resource, a scheduling request, a random access resource, or an active bandwidth part (BWP).

In some examples, a periodicity associated with the DTX enabled state is the same as a periodicity associated with a DTX disabled state of the second network entity, wherein the periodicity is aligned with a periodicity of extended reality (XR) transmissions associated with an XR service of the first network entity. In some cases, one or more of a DTX cycle periodicity associated with the DTX enabled state or a DRX cycle periodicity associated with a DRX enabled state of the second network entity is aligned with a non-integer periodicity corresponding to an extended reality (XR) video generation rate of the first network entity. In some examples, a start time associated with the first DRX on-duration is the same as or after a start time associated with the DTX on-duration, and an end time associated with the first DRX on-duration is the same as or before an end time associated with the DTX on-duration.

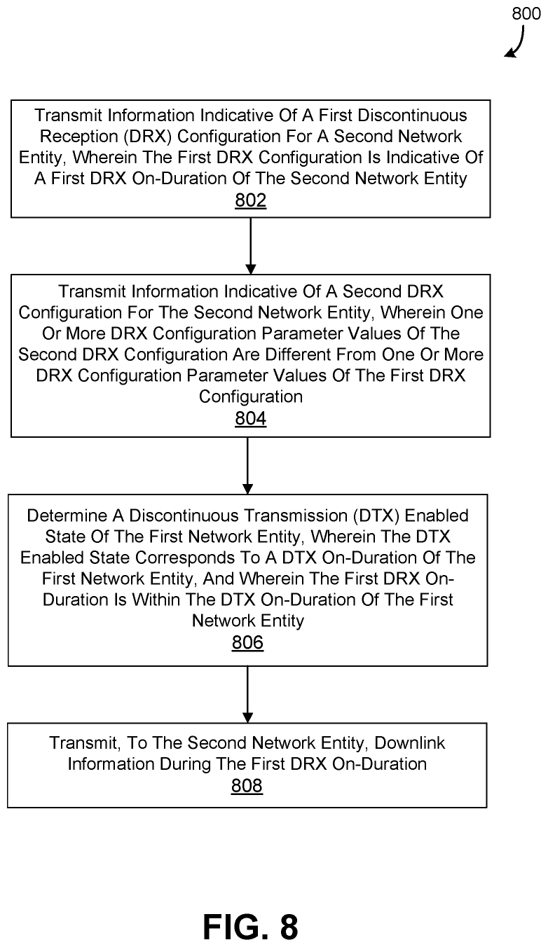

FIG. 8 is a flowchart diagram illustrating another example of a process 800 for wireless communications. The process 800 may be performed by a first network entity or by a component or system (e.g., a chipset) of the first network entity. The first network node may be a base station (e.g., a gNB, an eNB, or other base station), a portion of the base station (e.g., a CU, DU, RU, RIC, or other portion of a base station having a disaggregated architecture) or other type of network entity. In some examples, the first network entity can be a base station that is the same as or similar to one or more of the base stations of any of FIG. 1, FIG. 2, FIG. 3, etc. The operations of the process 800 may be implemented as software components that are executed and run on one or more processors (e.g., processor 910 of FIG. 9 or other processor(s)). Further, the transmission and reception of signals by the wireless communications device in the process 800 may be enabled, for example, by one or more antennas and/or one or more transceivers (e.g., antenna(s) and/or wireless transceiver(s) of any of FIG. 2, FIG. 4, FIG. 9, etc.).

At block 802, the first network entity (or component thereof) may transmit information indicative of a first discontinuous reception (DRX) configuration for a second network entity, wherein the first DRX configuration is indicative of a first DRX on-duration of the second network entity. For example, the second network entity can be the same as or similar to one or more of the UEs 104 of FIG. 1, the UE 104 of FIG. 2, the UEs 104 of FIG. 3, and/or the user device computing system 470 of FIG. 4. In some cases, the first DRX on-duration of the second network entity can be the same as or similar to one or more of the UE DRX on-durations 632, 642, 652 (and/or the UE DRX On-durations 634, 644, 654) of FIG. 6A. In some examples, the first DRXC configuration is associated with a discontinuous transmission (DTX) enabled state of the first network entity. For example, the first network entity can be a base station, gNB, etc., and may be the same as or similar to one or more of the base stations 102, 180 of FIG. 1, the base station 102 of FIG. 2, etc.

In some cases, the first DRX configuration includes a first plurality of values, wherein each value of the first plurality of values corresponds to a respective DRX configuration parameter of a plurality of DRX configuration parameters. For example, the plurality of DRX configuration parameters can include one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.

In some cases, to transmit information indicative of the first DRX configuration, the first network entity (or component thereof) may transmit, to the second network entity (e.g., UE.) a first Radio Resource Control (RRC) signal including the information indicative of the first DRX configuration.

In some cases, to transmit the information indicative of the first DRX configuration, the first network entity (or component thereof) may transmit configuration information associated with the first network entity (e.g., base station, gNB, etc.), wherein the configuration information includes the information indicative of the first DRX configuration. For instance, the first DRX configuration of the second network entity (e.g., UE) can be associated with the DTX enabled state of the first network entity (e.g., base station, gNB, etc.) In some cases, the first DRX configuration of the second network entity can be the same as or similar to a DTX configuration of the first network entity.

In some examples, the first DRX on-duration is overlapping in time with at least a portion of a respective DRX on-duration associated with each UE of a plurality of UEs, the first network entity included in the plurality of UEs. For example, the first DRX on-duration can be the same as or similar to the UE1 DRX on-duration 632 of FIG. 6A, which is overlapping in time with at least a portion of the respective DRX on-durations 642, 652 associated with a UE2 and UE3, respectively.

At block 804, the first network entity (or component thereof) may transmit information indicative of a second DRX configuration for the second network entity, wherein one or more DRX configuration parameter values of the second DRX configuration are different from one or more DRX configuration parameter values of the first DRX configuration. For example, the first DRX configuration (e.g., corresponding to the DTX enabled state of the first network entity) can include a first plurality of values, wherein each value of the first plurality of values corresponds to a respective DRX configuration parameter of a plurality of DRX configuration parameters. The second DRX configuration (e.g., corresponding to the DTX disabled state of the first network entity) can include a second plurality of values, wherein each value of the second plurality of values corresponds to a respective DRX configuration parameter of the plurality of DRX configuration parameters. At least one value of the second plurality of values corresponds to a particular DRX configuration parameter and is different from at least one value of the first plurality of values corresponding to the particular DRX configuration parameter. In some examples, the particular DRX configuration parameter includes one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.

At block 806, the first network entity (or component thereof) may determine a discontinuous transmission (DTX) enabled state of the first network entity, wherein the DTX enabled state corresponds to a DTX on-duration of the first network entity, and wherein the first DRX on-duration is within the DTX on-duration of the first network entity. In some cases, the DTX enabled state of the first network entity can correspond to the Cell-DTX on-duration 622 of FIG. 6A and/or can correspond to the cell-DTX cycle 620 of FIG. 6A. In some examples, the first network entity (or component thereof) can transmit, to the second network entity (e.g., UE) information indicative of the DTX enabled state of the first network entity. In some examples, the first network entity (or component thereof) can indicate, to the second network entity (e.g., UE), the DTX enabled state of the first network entity based on transmission or non-transmission of a signal relative to a period of time. For instance, the first network entity (or component thereof) can indicate the DTX enabled state of the first network entity based on non-transmission of the signal relative to the period of time. The first network entity (or component thereof) can indicate a DTX disabled state of the first network entity based on transmission of the signal relative to the period of time.

In some cases, the DTX enabled state is aligned with a DRX enabled state of the first network entity. For example, the DTX enabled state (e.g., DTX on-duration 622 of FIG. 6A) can be aligned with the DRX enabled state of the first network entity (e.g., DRX on-duration 612 of FIG. 6A). In some cases, the DTX enabled state of the first network entity can be aligned with the DRX enabled state of the first network entity based on a periodicity of the DTX enabled state (e.g., such as the cell-DTX cycle 620 of FIG. 6A) being a multiple of a periodicity of a DRX enabled state of the first network entity (e.g., such as the cell-DRX cycle 610 of FIG. 6A) or a periodicity of the DRX enabled state being a multiple of a periodicity of a DTX enabled state of the first network entity. In some cases, at least a portion of the DTX on-duration corresponding to the DTX enabled state overlaps with at least a portion of a DRX on-duration corresponding to the DRX enabled state.

In some examples, the periodicity of the DTX enabled state is the same as the periodicity of the DRX enabled state. For example, the cell-DTX cycle 620 of FIG. 6A can be the same as the cell-DRX cycle 610 of FIG. 6A. In some cases, the DTX enabled state is aligned with the DRX enabled state based on a DTX on-duration start offset associated with the periodicity of the DTX enabled state being the same as a DRX on-duration start offset associated with the periodicity of the DRX enabled state.

At block 808, the first network entity (or component thereof) may transmit, to the second network entity, downlink information during the first DRX on-duration. In some cases, the first DRX configuration is associated with the DTX enabled state of the first network entity and a channel type associated with the downlink information. For example, the channel type associated with the downlink information can be a configured grant Physical Uplink Shared Channel (PUSCH), a semi-persistent scheduled Physical Downlink Shared Channel (PDSCH), a Search Space Set (SSS), or an SSS group for Physical Downlink Control Channel (PDCCH) monitoring. In some cases, the channel type associated with the downlink information is associated with a Physical Uplink Control Channel (PUCCH) resource, a scheduling request, a random access resource, or an active bandwidth part (BWP).

In some examples, a periodicity associated with the DTX enabled state is the same as a periodicity associated with a DTX disabled state of the first network entity, wherein the periodicity is aligned with a periodicity of extended reality (XR) transmissions associated with an XR service of the second network entity (e.g., UE). In some cases, one or more of a DTX cycle periodicity associated with the DTX enabled state or a DRX cycle periodicity associated with a DRX enabled state of the first network entity is aligned with a non-integer periodicity corresponding to an extended reality (XR) video generation rate of the second network entity (e.g., UE). In some examples, a start time associated with the first DRX on-duration is the same as or after a start time associated with the DTX on-duration, and an end time associated with the first DRX on-duration is the same as or before an end time associated with the DTX on-duration.

In some examples, the processes described herein (e.g., process 700, process 800, and/or other process described herein) may be performed by a computing device or apparatus (e.g., a network node such as a UE, base station, a portion of a base station, etc.). For instance, as noted above, the process 700 may be performed by a UE and the process 800 may be performed by a base station or a portion of a base station. In another example, the process 700 and/or the process 800 may be performed by a computing device with the computing system 900 shown in FIG. 9. For instance, a wireless communication device with the computing architecture shown in FIG. 9 may include the components of the UE and may implement the operations of FIG. 7 and/or FIG. 8.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 700 and the process 800 are illustrated as a logical flow diagrams, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 700, the process 800, and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some aspects, computing system 900 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 915 of high-speed memory connected directly with, in close proximity to, or integrated as part of processor 910.

Processor 910 may include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some aspects, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. Illustrative aspects of the disclosure include:

Aspect 1. A first network entity for wireless communication, comprising: at least one memory; and at least one processor coupled to the at least one memory, wherein the at least one processor is configured to: receive information indicative of a first discontinuous reception (DRX) configuration for the first network entity, wherein the first DRX configuration is indicative of a first DRX on-duration of the first network entity; receive information indicative of a second DRX configuration for the first network entity, wherein one or more DRX configuration parameter values of the second DRX configuration are different from one or more DRX configuration parameter values of the first DRX configuration; determine a discontinuous transmission (DTX) enabled state of a second network entity, wherein the DTX enabled state corresponds to a DTX on-duration of the second network entity, and wherein the first DRX on-duration is within the DTX on-duration of the second network entity; and receive, from the second network entity, downlink information during the first DRX on-duration.

Aspect 2. The first network entity of Aspect 1, wherein: the first DRX configuration is associated with the DTX enabled state of the second network entity; and the second DRX configuration is associated with a DTX disabled state of the second network entity.

Aspect 3. The first network entity of any of Aspects 1 to 2, wherein the DTX enabled state is aligned with a DRX enabled state of the second network entity, based on: a periodicity of the DTX enabled state being a multiple of a periodicity of a DRX enabled state of the second network entity or a periodicity of the DRX enabled state being a multiple of a periodicity of a DTX enabled state of the second network entity; and at least a portion of the DTX on-duration corresponding to the DTX enabled state overlapping with at least a portion of a DRX on-duration corresponding to the DRX enabled state.

Aspect 4. The first network entity of Aspect 3, wherein: the periodicity of the DTX enabled state is the same as the periodicity of the DRX enabled state; and the DTX enabled state is aligned with the DRX enabled state based on a DTX on-duration start offset associated with the periodicity of the DTX enabled state being the same as a DRX on-duration start offset associated with the periodicity of the DRX enabled state.

Aspect 5. The first network entity of any of Aspects 1 to 4, wherein, to determine the DTX enabled state of the second network entity, the at least one processor is configured to: receive, from the second network entity, information indicative of the DTX enabled state of the second network entity.

Aspect 6. The first network entity of any of Aspects 1 to 5, wherein, to determine the DTX enabled state of the second network entity, the at least one processor is configured to: determine the DTX enabled state of the second network entity based on receipt or non-receipt of a signal relative to a period of time.

Aspect 7. The first network entity of Aspect 6, wherein the at least one processor is configured to: determine the DTX enabled state of the second network entity based on non-receipt of the signal relative to the period of time.

Aspect 8. The first network entity of any of Aspects 6 to 7, wherein the at least one processor is configured to: determine a DTX disabled state of the second network entity based on receipt of the signal relative to the period of time.

Aspect 9. The first network entity of any of Aspects 1 to 8, wherein: the first DRX configuration includes a first plurality of values, wherein each value of the first plurality of values corresponds to a respective DRX configuration parameter of a plurality of DRX configuration parameters; the second DRX configuration includes a second plurality of values, wherein each value of the second plurality of values corresponds to a respective DRX configuration parameter of the plurality of DRX configuration parameters; and at least one value of the second plurality of values corresponds to a particular DRX configuration parameter and is different from at least one value of the first plurality of values corresponding to the particular DRX configuration parameter.

Aspect 10. The first network entity of Aspect 9, wherein the particular DRX configuration parameter includes one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.

Aspect 11. The first network entity of any of Aspects 1 to 10, wherein the first DRX on-duration is overlapping in time with at least a portion of a respective DRX on-duration associated with each User Equipment (UE) of a plurality of UEs, the first network entity included in the plurality of UEs.

Aspect 12. The first network entity of Aspect 11, wherein the first DRX on-duration and the respective DRX on-duration associated with each UE of the plurality of UEs are within the DTX on-duration.

Aspect 13. The first network entity of any of Aspects 11 to 12, wherein the first DRX configuration is indicative of a first DRX on-duration start offset associated with the first network entity, and wherein the first DRX on-duration start offset is the same as a respective DRX on-duration start offset associated with each UE of the plurality of UEs.

Aspect 14. The first network entity of Aspect 13, wherein the first DRX on-duration start offset is a time offset from a beginning of a DTX cycle associated with the DTX enabled state.

Aspect 15. The first network entity of any of Aspects 11 to 14, wherein the first DRX configuration is indicative of a DRX cycle duration, and wherein the DRX cycle duration is the same as a DTX cycle duration associated with the DTX enabled state.

Aspect 16. The first network entity of any of Aspects 1 to 15, wherein the second DRX configuration is indicative of a second DRX on-duration of the first network entity and is associated with a DTX disabled state of the second network entity, and wherein the second DRX on-duration is non-overlapping in time with a respective DRX on-duration associated with each user equipment (UE) of a plurality of UEs.

Aspect 17. The first network entity of Aspect 16, wherein the at least one processor is further configured to: receive, from the second network entity, downlink information during the second DRX on-duration.

Aspect 18. The first network entity of any of Aspects 16 to 17 wherein the respective DRX on-duration associated with each UE of the plurality of UEs and the second DRX on-duration are associated with a same DRX cycle duration.

Aspect 19. The first network entity of any of Aspects 16 to 18, wherein: the second DRX configuration is indicative of a second DRX on-duration start offset associated with the first network entity, and wherein the second DRX on-duration start offset is different from a respective DRX on-duration start offset associated with each UE of the plurality of UEs.

Aspect 20. The first network entity of any of Aspects 1 to 19, wherein: to receive the information indicative of the first DRX configuration, the at least one processor is configured to receive, from the second network entity, a first Radio Resource Control (RRC) signal including the information indicative of the first DRX configuration; and to receive the information indicative of the second DRX configuration, the at least one processor is configured to receive, from the second network entity, a second RRC signal including the information indicative of the second DRX configuration.

Aspect 21. The first network entity of any of Aspects 1 to 20, wherein, to receive the information indicative of the first DRX configuration and to receive the information indicative of the second DRX configuration, the at least one processor is configured to: receive, from the second network entity, a Radio Resource Control (RRC) signal including the information indicative of the first DRX configuration and including the information indicative of the second DRX configuration.

Aspect 22. The first network entity of Aspect 21, wherein the RRC signal is indicative of one or more DRX configuration parameters, and wherein each respective DRX configuration parameter of the one or more DRX configuration parameters is associated with a first value corresponding to the first DRX configuration and a second value corresponding to the second DRX configuration.

Aspect 23. The first network entity of any of Aspects 1 to 22, wherein, to receive the information indicative of the first DRX configuration, the at least one processor is configured to: receive configuration information associated with the second network entity, wherein the configuration information includes the information indicative of the first DRX configuration.

Aspect 24. The first network entity of Aspect 23, wherein the at least one processor is configured to: replace a DRX on-duration start offset parameter value included in the second DRX configuration with a respective on-duration start offset parameter value included in the configuration information associated with the second network entity; or replace a DRX cycle duration parameter value included in the second DRX configuration with a respective cycle duration parameter value included in the configuration information associated with the second network entity.

Aspect 25. The first network entity of any of Aspects 23 to 24, wherein the configuration information associated with the second network entity includes one or more of a DRX configuration associated with the second network entity or a DTX configuration associated with the second network entity.

Aspect 26. The first network entity of any of Aspects 1 to 25, wherein the first DRX configuration is associated with the DTX enabled state of the second network entity and a channel type associated with the downlink information.

Aspect 27. The first network entity of Aspect 26, wherein the channel type associated with the downlink information is a configured grant Physical Uplink Shared Channel (PUSCH), a semi-persistent scheduled Physical Downlink Shared Channel (PDSCH), a Search Space Set (SSS), or an SSS group for Physical Downlink Control Channel (PDCCH) monitoring.

Aspect 28. The first network entity of any of Aspects 26 to 27, wherein the channel type associated with the downlink information is associated with a Physical Uplink Control Channel (PUCCH) resource, a scheduling request, a random access resource, or an active bandwidth part (BWP).

Aspect 29. The first network entity of any of Aspects 1 to 28, wherein a periodicity associated with the DTX enabled state is the same as a periodicity associated with a DTX disabled state of the second network entity, and wherein the periodicity is aligned with a periodicity of extended reality (XR) transmissions associated with an XR service of the first network entity.

Aspect 30. The first network entity of any of Aspects 1 to 29, wherein one or more of a DTX cycle periodicity associated with the DTX enabled state or a DRX cycle periodicity associated with a DRX enabled state of the second network entity is aligned with a non-integer periodicity corresponding to an extended reality (XR) video generation rate of the first network entity.

Aspect 31. The first network entity of any of Aspects 1 to 30, wherein: a start time associated with the first DRX on-duration is the same as or after a start time associated with the DTX on-duration; and an end time associated with the first DRX on-duration is the same as or before an end time associated with the DTX on-duration.

Aspect 32. A first network entity for wireless communication, comprising: at least one memory; and at least one processor coupled to the at least one memory, wherein the at least one processor is configured to: transmit information indicative of a first discontinuous reception (DRX) configuration for a second network entity, wherein the first DRX configuration is indicative of a first DRX on-duration of the second network entity; transmit information indicative of a second DRX configuration for the second network entity, wherein one or more DRX configuration parameter values of the second DRX configuration are different from one or more DRX configuration parameter values of the first DRX configuration; determine a discontinuous transmission (DTX) enabled state of the first network entity, wherein the DTX enabled state corresponds to a DTX on-duration of the first network entity, and wherein the first DRX on-duration is within the DTX on-duration of the first network entity; and transmit, to the second network entity, downlink information during the first DRX on-duration.

Aspect 33. The first network entity of Aspect 32, wherein: the first DRX configuration is associated with the DTX enabled state of the first network entity; and the second DRX configuration is associated with a DTX disabled state of the first network entity.

Aspect 34. The first network entity of any of Aspects 32 to 33, wherein the DTX enabled state is aligned with a DRX enabled state of the first network entity, based on: a periodicity of the DTX enabled state being a multiple of a periodicity of a DRX enabled state of the first network entity or a periodicity of the DRX enabled state being a multiple of a periodicity of a DTX enabled state of the first network entity; and at least a portion of the DTX on-duration corresponding to the DTX enabled state overlapping with at least a portion of a DRX on-duration corresponding to the DRX enabled state.

Aspect 35. The first network entity of Aspect 34, wherein: the periodicity of the DTX enabled state is the same as the periodicity of the DRX enabled state; and the DTX enabled state is aligned with the DRX enabled state based on a DTX on-duration start offset associated with the periodicity of the DTX enabled state being the same as a DRX on-duration start offset associated with the periodicity of the DRX enabled state.

Aspect 36. The first network entity of any of Aspects 32 to 35, wherein the at least one processor is configured to: transmit, to the second network entity, information indicative of the DTX enabled state of the first network entity.

Aspect 37. The first network entity of any of Aspects 32 to 36, wherein the at least one processor is configured to: indicate, to the second network entity, the DTX enabled state of the first network entity based on transmission or non-transmission of a signal relative to a period of time.

Aspect 38. The first network entity of Aspect 37, wherein the at least one processor is configured to: indicate the DTX enabled state of the first network entity based on non-transmission of the signal relative to the period of time.

Aspect 39. The first network entity of any of Aspects 37 to 38, wherein the at least one processor is configured to: indicate a DTX disabled state of the first network entity based on transmission of the signal relative to the period of time.

Aspect 40. The first network entity of any of Aspects 32 to 39, wherein: the first DRX configuration includes a first plurality of values, wherein each value of the first plurality of values corresponds to a respective DRX configuration parameter of a plurality of DRX configuration parameters; the second DRX configuration includes a second plurality of values, wherein each value of the second plurality of values corresponds to a respective DRX configuration parameter of the plurality of DRX configuration parameters; and at least one value of the second plurality of values corresponds to a particular DRX configuration parameter and is different from at least one value of the first plurality of values corresponding to the particular DRX configuration parameter.

Aspect 41. The first network entity of Aspect 40, wherein the particular DRX configuration parameter includes one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.

Aspect 42. The first network entity of any of Aspects 32 to 41, wherein the first DRX on-duration is overlapping in time with at least a portion of a respective DRX on-duration associated with each User Equipment (UE) of a plurality of UEs, the second network entity included in the plurality of UEs.

Aspect 43. The first network entity of Aspect 42, wherein the first DRX on-duration and the respective DRX on-duration associated with each UE of the plurality of UEs are within the DTX on-duration.

Aspect 44. The first network entity of any of Aspects 42 to 43, wherein the first DRX configuration is indicative of a first DRX on-duration start offset associated with the second network entity, and wherein the first DRX on-duration start offset is the same as a respective DRX on-duration start offset associated with each UE of the plurality of UEs.

Aspect 45. The first network entity of Aspect 44, wherein the first DRX on-duration start offset is a time offset from a beginning of a DTX cycle associated with the DTX enabled state.

Aspect 46. The first network entity of any of Aspects 42 to 45, wherein the first DRX configuration is indicative of a DRX cycle duration, and wherein the DRX cycle duration is the same as a DTX cycle duration associated with the DTX enabled state.

Aspect 47. The first network entity of any of Aspects 32 to 46, wherein the second DRX configuration is indicative of a second DRX on-duration of the second network entity and is associated with a DTX disabled state of the first network entity, and wherein the second DRX on-duration is non-overlapping in time with a respective DRX on-duration associated with each user equipment (UE) of a plurality of UEs.

Aspect 48. The first network entity of Aspect 47, wherein the at least one processor is further configured to: transmit, to the second network entity, downlink information during the second DRX on-duration.

Aspect 49. The first network entity of any of Aspects 47 to 48 wherein the respective DRX on-duration associated with each UE of the plurality of UEs and the second DRX on-duration are associated with a same DRX cycle duration.

Aspect 50. The first network entity of any of Aspects 47 to 48, wherein: the second DRX configuration is indicative of a second DRX on-duration start offset associated with the second network entity, and wherein the second DRX on-duration start offset is different from a respective DRX on-duration start offset associated with each UE of the plurality of UEs.

Aspect 51. The first network entity of any of Aspects 32 to 50, wherein: to transmit the information indicative of the first DRX configuration, the at least one processor is configured to transmit, to the second network entity, a first Radio Resource Control (RRC) signal including the information indicative of the first DRX configuration; and to transmit the information indicative of the second DRX configuration, the at least one processor is configured to transmit, to the second network entity, a second RRC signal including the information indicative of the second DRX configuration.

Aspect 52. The first network entity of any of Aspects 32 to 51, wherein, to transmit the information indicative of the first DRX configuration and to transmit the information indicative of the second DRX configuration, the at least one processor is configured to: transmit, to the second network entity, a Radio Resource Control (RRC) signal including the information indicative of the first DRX configuration and including the information indicative of the second DRX configuration.

Aspect 53. The first network entity of Aspect 52, wherein the RRC signal is indicative of one or more DRX configuration parameters, and wherein each respective DRX configuration parameter of the one or more DRX configuration parameters is associated with a first value corresponding to the first DRX configuration and a second value corresponding to the second DRX configuration.

Aspect 54. The first network entity of any of Aspects 32 to 53, wherein, to transmit the information indicative of the first DRX configuration, the at least one processor is configured to: transmit configuration information associated with the first network entity, wherein the configuration information includes the information indicative of the first DRX configuration.

Aspect 55. The first network entity of Aspect 54, wherein the at least one processor is configured to: replace a DRX on-duration start offset parameter value included in the second DRX configuration with a respective on-duration start offset parameter value included in the configuration information associated with the first network entity; or replace a DRX cycle duration parameter value included in the second DRX configuration with a respective cycle duration parameter value included in the configuration information associated with the first network entity.

Aspect 56. The first network entity of any of Aspects 54 to 55, wherein the configuration information associated with the first network entity includes one or more of a DRX configuration associated with the first network entity or a DTX configuration associated with the first network entity.

Aspect 57. The first network entity of any of Aspects 32 to 56, wherein the first DRX configuration for the is associated with the DTX enabled state of the first network entity and a channel type associated with the downlink information.

Aspect 58. The first network entity of Aspect 57, wherein the channel type associated with the downlink information is a configured grant Physical Uplink Shared Channel (PUSCH), a semi-persistent scheduled Physical Downlink Shared Channel (PDSCH), a Search Space Set (SSS), or an SSS group for Physical Downlink Control Channel (PDCCH) monitoring.

Aspect 59. The first network entity of any of Aspects 57 to 58, wherein the channel type associated with the downlink information is associated with a Physical Uplink Control Channel (PUCCH) resource, a scheduling request, a random access resource, or an active bandwidth part (BWP).

Aspect 60. The first network entity of any of Aspects 32 to 59, wherein a periodicity associated with the DTX enabled state is the same as a periodicity associated with the a DTX disabled state of the first network entity, and wherein the periodicity is aligned with a periodicity of extended reality (XR) transmissions associated with an XR service of the second network entity.

Aspect 61. The first network entity of any of Aspects 32 to 60, wherein one or more of a DTX cycle periodicity associated with the DTX enabled state or a DRX cycle periodicity associated with a DRX enabled state of the first network entity is aligned with a non-integer periodicity corresponding to an extended reality (XR) video generation rate of the second network entity.

Aspect 62. The first network entity of any of Aspects 32 to 61, wherein: a start time associated with the first DRX on-duration is the same as or after a start time associated with the DTX on-duration; and an end time associated with the first DRX on-duration is the same as or before an end time associated with the DTX on-duration.

Aspect 63. A method for wireless communication at a first network entity, comprising: receiving information indicative of a first discontinuous reception (DRX) configuration for the first network entity, wherein the first DRX configuration is indicative of a first DRX on-duration of the first network entity; receiving information indicative of a second DRX configuration for the first network entity, wherein one or more DRX configuration parameter values of the second DRX configuration are different from one or more DRX configuration parameter values of the first DRX configuration; determining a discontinuous transmission (DTX) enabled state of a second network entity, wherein the DTX enabled state corresponds to a DTX on-duration of the second network entity, and wherein the first DRX on-duration is within the DTX on-duration of the second network entity; and receiving, from the second network entity, downlink information during the first DRX on-duration.

Aspect 64. The method of Aspect 63, wherein: the first DRX configuration is associated with the DTX enabled state of the second network entity; and the second DRX configuration is associated with a DTX disabled state of the second network entity.

Aspect 65. The method of any of Aspects 63 to 64, wherein the DTX enabled state is aligned with a DRX enabled state of the second network entity, based on: a periodicity of the DTX enabled state being a multiple of a periodicity of a DRX enabled state of the second network entity or a periodicity of the DRX enabled state being a multiple of a periodicity of a DTX enabled state of the second network entity; and at least a portion of the DTX on-duration corresponding to the DTX enabled state overlapping with at least a portion of a DRX on-duration corresponding to the DRX enabled state.

Aspect 66. The method of Aspect 65, wherein: the periodicity of the DTX enabled state is the same as the periodicity of the DRX enabled state; and the DTX enabled state is aligned with the DRX enabled state based on a DTX on-duration start offset associated with the periodicity of the DTX enabled state being the same as a DRX on-duration start offset associated with the periodicity of the DRX enabled state.

Aspect 67. The method of any of Aspects 63 to 66, wherein determining the DTX enabled state of the second network entity comprises: receiving, from the second network entity, information indicative of the DTX enabled state of the second network entity.

Aspect 68. The method of any of Aspects 63 to 67, wherein determining the DTX enabled state of the second network entity comprises: determining the DTX enabled state of the second network entity based on receipt or non-receipt of a signal relative to a period of time.

Aspect 69. The method of Aspect 68, further comprising: determining the DTX enabled state of the second network entity based on non-receipt of the signal relative to the period of time.

Aspect 70. The method of any of Aspects 68 to 69, further comprising: determining a DTX disabled state of the second network entity based on receipt of the signal relative to the period of time.

Aspect 71. The method of any of Aspects 63 to 70, wherein: the first DRX configuration includes a first plurality of values, wherein each value of the first plurality of values corresponds to a respective DRX configuration parameter of a plurality of DRX configuration parameters; the second DRX configuration includes a second plurality of values, wherein each value of the second plurality of values corresponds to a respective DRX configuration parameter of the plurality of DRX configuration parameters; and at least one value of the second plurality of values corresponds to a particular DRX configuration parameter and is different from at least one value of the first plurality of values corresponding to the particular DRX configuration parameter.

Aspect 72. The method of Aspect 71, wherein the particular DRX configuration parameter includes one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.

Aspect 73. The method of any of Aspects 63 to 72, wherein the first DRX on-duration is overlapping in time with at least a portion of a respective DRX on-duration associated with each User Equipment (UE) of a plurality of UEs, the first network entity included in the plurality of UEs.

Aspect 74. The method of Aspect 73, wherein the first DRX on-duration and the respective DRX on-duration associated with each UE of the plurality of UEs are within the DTX on-duration.

Aspect 75. The method of any of Aspects 73 to 74, wherein the first DRX configuration is indicative of a first DRX on-duration start offset associated with the first network entity, and wherein the first DRX on-duration start offset is the same as a respective DRX on-duration start offset associated with each UE of the plurality of UEs.

Aspect 76. The method of Aspect 75, wherein the first DRX on-duration start offset is a time offset from a beginning of a DTX cycle associated with the DTX enabled state.

Aspect 77. The method of any of Aspects 73 to 76, wherein the first DRX configuration is indicative of a DRX cycle duration, and wherein the DRX cycle duration is the same as a DTX cycle duration associated with the DTX enabled state.

Aspect 78. The method of any of Aspects 63 to 77, wherein the second DRX configuration is indicative of a second DRX on-duration of the first network entity and is associated with a DTX disabled state of the second network entity, and wherein the second DRX on-duration is non-overlapping in time with a respective DRX on-duration associated with each user equipment (UE) of a plurality of UEs.

Aspect 79. The method of Aspect 78, further comprising: receiving, from the second network entity, downlink information during the second DRX on-duration.

Aspect 80. The method of any of Aspects 78 to 79 wherein the respective DRX on-duration associated with each UE of the plurality of UEs and the second DRX on-duration are associated with a same DRX cycle duration.

Aspect 81. The method of any of Aspects 78 to 80, wherein: the second DRX configuration is indicative of a second DRX on-duration start offset associated with the first network entity, and wherein the second DRX on-duration start offset is different from a respective DRX on-duration start offset associated with each UE of the plurality of UEs.

Aspect 82. The method of any of Aspects 63 to 81, wherein: receiving the information indicative of the first DRX configuration comprises receiving, from the second network entity, a first Radio Resource Control (RRC) signal including the information indicative of the first DRX configuration; and receiving the information indicative of the second DRX configuration comprises receiving, from the second network entity, a second RRC signal including the information indicative of the second DRX configuration.

Aspect 83. The method of any of Aspects 63 to 82, wherein receiving the information indicative of the first DRX configuration and receiving the information indicative of the second DRX configuration comprises: receiving, from the second network entity, a Radio Resource Control (RRC) signal including the information indicative of the first DRX configuration and including the information indicative of the second DRX configuration.

Aspect 84. The method of Aspect 83, wherein the RRC signal is indicative of one or more DRX configuration parameters, and wherein each respective DRX configuration parameter of the one or more DRX configuration parameters is associated with a first value corresponding to the first DRX configuration and a second value corresponding to the second DRX configuration.

Aspect 85. The method of any of Aspects 63 to 84, wherein receiving the information indicative of the first DRX configuration comprises: receiving configuration information associated with the second network entity, wherein the configuration information includes the information indicative of the first DRX configuration.

Aspect 86. The method of Aspect 85, further comprising: replacing a DRX on-duration start offset parameter value included in the second DRX configuration with a respective on-duration start offset parameter value included in the configuration information associated with the second network entity; or replacing a DRX cycle duration parameter value included in the second DRX configuration with a respective cycle duration parameter value included in the configuration information associated with the second network entity.

Aspect 87. The method of any of Aspects 85 to 86, wherein the configuration information associated with the second network entity includes one or more of a DRX configuration associated with the second network entity or a DTX configuration associated with the second network entity.

Aspect 88. The method of any of Aspects 63 to 87, wherein the first DRX configuration is associated with the DTX enabled state of the second network entity and a channel type associated with the downlink information.

Aspect 89. The method of Aspect 88, wherein the channel type associated with the downlink information is a configured grant Physical Uplink Shared Channel (PUSCH), a semi-persistent scheduled Physical Downlink Shared Channel (PDSCH), a Search Space Set (SSS), or an SSS group for Physical Downlink Control Channel (PDCCH) monitoring.

Aspect 90. The method of any of Aspects 88 to 89, wherein the channel type associated with the downlink information is associated with a Physical Uplink Control Channel (PUCCH) resource, a scheduling request, a random access resource, or an active bandwidth part (BWP).

Aspect 91. The method of any of Aspects 63 to 90, wherein a periodicity associated with the DTX enabled state is the same as a periodicity associated with the a DTX disabled state of the second network entity, and wherein the periodicity is aligned with a periodicity of extended reality (XR) transmissions associated with an XR service of the first network entity.

Aspect 92. The method of any of Aspects 63 to 91, wherein one or more of a DTX cycle periodicity associated with the DTX enabled state or a DRX cycle periodicity associated with a DRX enabled state of the second network entity is aligned with a non-integer periodicity corresponding to an extended reality (XR) video generation rate of the first network entity.

Aspect 93. The method of any of Aspects 63 to 92, wherein: a start time associated with the first DRX on-duration is the same as or after a start time associated with the DTX on-duration; and an end time associated with the first DRX on-duration is the same as or before an end time associated with the DTX on-duration.

Aspect 94. A method for wireless communication at a first network entity, comprising: transmitting information indicative of a first discontinuous reception (DRX) configuration for a second network entity, wherein the first DRX configuration is indicative of a first DRX on-duration of the second network entity; transmitting information indicative of a second DRX configuration for the second network entity, wherein one or more DRX configuration parameter values of the second DRX configuration are different from one or more DRX configuration parameter values of the first DRX configuration; determining a discontinuous transmission (DTX) enabled state of the first network entity, wherein the DTX enabled state corresponds to a DTX on-duration of the first network entity, and wherein the first DRX on-duration is within the DTX on-duration of the first network entity; and transmitting, to the second network entity, downlink information during the first DRX on-duration.

Aspect 95. The method of Aspect 94, wherein: the first DRX configuration is associated with the DTX enabled state of the first network entity; and the second DRX configuration is associated with a DTX disabled state of the first network entity.

Aspect 96. The method of any of Aspects 94 to 95, wherein the DTX enabled state is aligned with a DRX enabled state of the first network entity, based on: a periodicity of the DTX enabled state being a multiple of a periodicity of a DRX enabled state of the first network entity or a periodicity of the DRX enabled state being a multiple of a periodicity of a DTX enabled state of the first network entity; and at least a portion of the DTX on-duration corresponding to the DTX enabled state overlapping with at least a portion of a DRX on-duration corresponding to the DRX enabled state.

Aspect 97. The method of Aspect 96 wherein: the periodicity of the DTX enabled state is the same as the periodicity of the DRX enabled state; and the DTX enabled state is aligned with the DRX enabled state based on a DTX on-duration start offset associated with the periodicity of the DTX enabled state being the same as a DRX on-duration start offset associated with the periodicity of the DRX enabled state.

Aspect 98. The method of any of Aspects 94 to 97, wherein the at least one processor is configured to: transmit, to the second network entity, information indicative of the DTX enabled state of the first network entity.

Aspect 99. The method of any of Aspects 94 to 98, further comprising: indicating, to the second network entity, the DTX enabled state of the first network entity based on transmission or non-transmission of a signal relative to a period of time.

Aspect 100. The method of Aspect 99, further comprising: indicating the DTX enabled state of the first network entity based on non-transmission of the signal relative to the period of time.

Aspect 101. The method of any of Aspects 99 to 100, further comprising: indicating a DTX disabled state of the first network entity based on transmission of the signal relative to the period of time.

Aspect 102. The method of any of Aspects 94 to 101, wherein: the first DRX configuration includes a first plurality of values, wherein each value of the first plurality of values corresponds to a respective DRX configuration parameter of a plurality of DRX configuration parameters; the second DRX configuration includes a second plurality of values, wherein each value of the second plurality of values corresponds to a respective DRX configuration parameter of the plurality of DRX configuration parameters; and at least one value of the second plurality of values corresponds to a particular DRX configuration parameter and is different from at least one value of the first plurality of values corresponding to the particular DRX configuration parameter.

Aspect 103. The method of Aspect 102, wherein the particular DRX configuration parameter includes one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.

Aspect 104. The method of any of Aspects 94 to 103, wherein the first DRX on-duration is overlapping in time with at least a portion of a respective DRX on-duration associated with each User Equipment (UE) of a plurality of UEs, the second network entity included in the plurality of UEs.

Aspect 105. The method of Aspect 104, wherein the first DRX on-duration and the respective DRX on-duration associated with each UE of the plurality of UEs are within the DTX on-duration.

Aspect 106. The method of any of Aspects 104 to 105, wherein the first DRX configuration is indicative of a first DRX on-duration start offset associated with the second network entity, and wherein the first DRX on-duration start offset is the same as a respective DRX on-duration start offset associated with each UE of the plurality of UEs.

Aspect 107. The method of Aspect 106, wherein the first DRX on-duration start offset is a time offset from a beginning of a DTX cycle associated with the DTX enabled state.

Aspect 108. The method of any of Aspects 104 to 107, wherein the first DRX configuration is indicative of a DRX cycle duration, and wherein the DRX cycle duration is the same as a DTX cycle duration associated with the DTX enabled state.

Aspect 109. The method of any of Aspects 94 to 108, wherein the second DRX configuration is indicative of a second DRX on-duration of the second network entity and is associated with a DTX disabled state of the first network entity, and wherein the second DRX on-duration is non-overlapping in time with a respective DRX on-duration associated with each user equipment (UE) of a plurality of UEs.

Aspect 110. The method of Aspect 109, further comprising: transmitting, to the second network entity, downlink information during the second DRX on-duration.

Aspect 111. The method of any of Aspects 109 to 110, wherein the respective DRX on-duration associated with each UE of the plurality of UEs and the second DRX on-duration are associated with a same DRX cycle duration.

Aspect 112. The method of Aspect 109, wherein: the second DRX configuration is indicative of a second DRX on-duration start offset associated with the second network entity, and wherein the second DRX on-duration start offset is different from a respective DRX on-duration start offset associated with each UE of the plurality of UEs.

Aspect 113. The method of Aspect 94, wherein: transmitting the information indicative of the first DRX configuration comprises transmitting, to the second network entity, a first Radio Resource Control (RRC) signal including the information indicative of the first DRX configuration; and transmitting the information indicative of the second DRX configuration comprises transmitting, to the second network entity, a second RRC signal including the information indicative of the second DRX configuration.

Aspect 114. The method of Aspect 94, wherein transmitting the information indicative of the first DRX configuration and transmitting the information indicative of the second DRX configuration comprises: transmitting, to the second network entity, a Radio Resource Control (RRC) signal including the information indicative of the first DRX configuration and including the information indicative of the second DRX configuration.

Aspect 115. The method of Aspect 114, wherein the RRC signal is indicative of one or more DRX configuration parameters, and wherein each respective DRX configuration parameter of the one or more DRX configuration parameters is associated with a first value corresponding to the first DRX configuration and a second value corresponding to the second DRX configuration.

Aspect 116. The method of any of Aspects 94 to 115, wherein transmitting the information indicative of the first DRX configuration comprises: transmitting configuration information associated with the first network entity, wherein the configuration information includes the information indicative of the first DRX configuration.

Aspect 117. The method of Aspect 116, further comprising: replacing a DRX on-duration start offset parameter value included in the second DRX configuration with a respective on-duration start offset parameter value included in the configuration information associated with the first network entity; or replacing a DRX cycle duration parameter value included in the second DRX configuration with a respective cycle duration parameter value included in the configuration information associated with the first network entity.

Aspect 118. The method of any of Aspects 116 to 117, wherein the configuration information associated with the first network entity includes one or more of a DRX configuration associated with the first network entity or a DTX configuration associated with the first network entity.

Aspect 119. The method of any of Aspects 94 to 118, wherein the first DRX configuration for the is associated with the DTX enabled state of the first network entity and a channel type associated with the downlink information.

Aspect 120. The method of Aspect 119, wherein the channel type associated with the downlink information is a configured grant Physical Uplink Shared Channel (PUSCH), a semi-persistent scheduled Physical Downlink Shared Channel (PDSCH), a Search Space Set (SSS), or an SSS group for Physical Downlink Control Channel (PDCCH) monitoring.

Aspect 121. The method of any of Aspects 119 to 120, wherein the channel type associated with the downlink information is associated with a Physical Uplink Control Channel (PUCCH) resource, a scheduling request, a random access resource, or an active bandwidth part (BWP).

Aspect 122. The method of any of Aspects 94 to 121, wherein a periodicity associated with the DTX enabled state is the same as a periodicity associated with the a DTX disabled state of the first network entity, and wherein the periodicity is aligned with a periodicity of extended reality (XR) transmissions associated with an XR service of the second network entity.

Aspect 123. The method of any of Aspects 94 to 122, wherein one or more of a DTX cycle periodicity associated with the DTX enabled state or a DRX cycle periodicity associated with a DRX enabled state of the first network entity is aligned with a non-integer periodicity corresponding to an extended reality (XR) video generation rate of the second network entity.

Aspect 124. The method of any of Aspects 94 to 123, wherein: a start time associated with the first DRX on-duration is the same as or after a start time associated with the DTX on-duration; and an end time associated with the first DRX on-duration is the same as or before an end time associated with the DTX on-duration.

Aspect 125. A non-transitory computer-readable medium having instructions thereon that, when executed by one or more processors, cause the one or more processors to perform operations according to any of Aspects 1 to 31.

Aspect 126. A non-transitory computer-readable medium having instructions thereon that, when executed by one or more processors, cause the one or more processors to perform operations according to any of Aspects 32 to 62.

Aspect 127. A non-transitory computer-readable medium having instructions thereon that, when executed by one or more processors, cause the one or more processors to perform operations according to any of Aspects 63 to 93.

Aspect 128. A non-transitory computer-readable medium having instructions thereon that, when executed by one or more processors, cause the one or more processors to perform operations according to any of Aspects 94 to 124.

Aspect 129. An apparatus for wireless communication, comprising one or more means for performing operations according to any of Aspects 1 to 31.

Aspect 130. An apparatus for wireless communication, comprising one or more means for performing operations according to any of Aspects 32 to 62.

Aspect 131. An apparatus for wireless communication, comprising one or more means for performing operations according to any of Aspects 63 to 93.

Aspect 132. An apparatus for wireless communication, comprising one or more means for performing operations according to any of Aspects 94 to 124.

What is claimed is:

1. A first network entity for wireless communication, comprising:
at least one memory; and
at least one processor coupled to the at least one memory, wherein the at least one processor is configured to:
receive information indicative of a first discontinuous reception (DRX) configuration for the first network entity, wherein the first DRX configuration is indicative of a first DRX on-duration of the first network entity;
receive information indicative of a second DRX configuration for the first network entity, wherein one or more DRX configuration parameter values of the second DRX configuration are different from one or more DRX configuration parameter values of the first DRX configuration;
determine a discontinuous transmission (DTX) enabled state of a second network entity, wherein the DTX enabled state corresponds to a DTX on-duration of the second network entity, and wherein the first DRX on-duration is within the DTX on-duration of the second network entity; and
receive, from the second network entity, downlink information during the first DRX on-duration.

2. The first network entity of claim 1, wherein:
the first DRX configuration is associated with the DTX enabled state of the second network entity; and
the second DRX configuration is associated with a DTX disabled state of the second network entity.

3. The first network entity of claim 1, wherein the DTX enabled state is aligned with a DRX enabled state of the second network entity, based on:
a periodicity of the DTX enabled state being a multiple of a periodicity of a DRX enabled state of the second network entity or a periodicity of the DRX enabled state being a multiple of a periodicity of a DTX enabled state of the second network entity; and
at least a portion of the DTX on-duration corresponding to the DTX enabled state overlapping with at least a portion of a DRX on-duration corresponding to the DRX enabled state.

4. The first network entity of claim 3, wherein:
the periodicity of the DTX enabled state is the same as the periodicity of the DRX enabled state; and
the DTX enabled state is aligned with the DRX enabled state based on a DTX on-duration start offset associated with the periodicity of the DTX enabled state being the same as a DRX on-duration start offset associated with the periodicity of the DRX enabled state.

5. The first network entity of claim 1, wherein, to determine the DTX enabled state of the second network entity, the at least one processor is configured to:
receive, from the second network entity, information indicative of the DTX enabled state of the second network entity.

6. The first network entity of claim 1, wherein, to determine the DTX enabled state of the second network entity, the at least one processor is configured to:
determine the DTX enabled state of the second network entity based on receipt or non-receipt of a signal relative to a period of time.

7. The first network entity of claim 6, wherein the at least one processor is configured to:
determine the DTX enabled state of the second network entity based on non-receipt of the signal relative to the period of time.

8. The first network entity of claim 6, wherein the at least one processor is configured to:
determine a DTX disabled state of the second network entity based on receipt of the signal relative to the period of time.

9. The first network entity of claim 1, wherein:
the first DRX configuration includes a first plurality of values, wherein each value of the first plurality of values corresponds to a respective DRX configuration parameter of a plurality of DRX configuration parameters;
the second DRX configuration includes a second plurality of values, wherein each value of the second plurality of values corresponds to a respective DRX configuration parameter of the plurality of DRX configuration parameters; and
at least one value of the second plurality of values corresponds to a particular DRX configuration parameter and is different from at least one value of the first plurality of values corresponding to the particular DRX configuration parameter.

10. The first network entity of claim 9, wherein the particular DRX configuration parameter includes one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.

11. The first network entity of claim 1, wherein the first DRX on-duration is overlapping in time with at least a portion of a respective DRX on-duration associated with each User Equipment (UE) of a plurality of UEs, the first network entity included in the plurality of UEs.

12. The first network entity of claim 11, wherein the first DRX on-duration and the respective DRX on-duration associated with each UE of the plurality of UEs are within the DTX on-duration.

13. The first network entity of claim 11, wherein the first DRX configuration is indicative of a first DRX on-duration start offset associated with the first network entity, and wherein the first DRX on-duration start offset is the same as a respective DRX on-duration start offset associated with each UE of the plurality of UEs.

14. The first network entity of claim 13, wherein the first DRX on-duration start offset is a time offset from a beginning of a DTX cycle associated with the DTX enabled state.

15. The first network entity of claim 11, wherein the first DRX configuration is indicative of a DRX cycle duration, and wherein the DRX cycle duration is the same as a DTX cycle duration associated with the DTX enabled state.

16. The first network entity of claim 1, wherein the second DRX configuration is indicative of a second DRX on-duration of the first network entity and is associated with a DTX disabled state of the second network entity, and wherein the second DRX on-duration is non-overlapping in time with a respective DRX on-duration associated with each user equipment (UE) of a plurality of UEs.

17. The first network entity of claim 16, wherein the at least one processor is further configured to:
receive, from the second network entity, downlink information during the second DRX on-duration.

18. The first network entity of claim 16, wherein the respective DRX on-duration associated with each UE of the plurality of UEs and the second DRX on-duration are associated with a same DRX cycle duration.

19. The first network entity of claim 16, wherein:
the second DRX configuration is indicative of a second DRX on-duration start offset associated with the first network entity, and wherein the second DRX on-duration start offset is different from a respective DRX on-duration start offset associated with each UE of the plurality of UEs.

20. The first network entity of claim 1, wherein:
to receive the information indicative of the first DRX configuration, the at least one processor is configured to receive, from the second network entity, a first Radio Resource Control (RRC) signal including the information indicative of the first DRX configuration; and
to receive the information indicative of the second DRX configuration, the at least one processor is configured to receive, from the second network entity, a second RRC signal including the information indicative of the second DRX configuration.

21. The first network entity of claim 1, wherein, to receive the information indicative of the first DRX configuration and to receive the information indicative of the second DRX configuration, the at least one processor is configured to:
receive, from the second network entity, a Radio Resource Control (RRC) signal including the information indicative of the first DRX configuration and including the information indicative of the second DRX configuration.

22. The first network entity of claim 21, wherein the RRC signal is indicative of one or more DRX configuration parameters, and wherein each respective DRX configuration parameter of the one or more DRX configuration parameters is associated with a first value corresponding to the first DRX configuration and a second value corresponding to the second DRX configuration.

23. The first network entity of claim 1, wherein, to receive the information indicative of the first DRX configuration, the at least one processor is configured to:
receive configuration information associated with the second network entity, wherein the configuration information includes the information indicative of the first DRX configuration.

24. The first network entity of claim 23, wherein the at least one processor is configured to:
replace a DRX on-duration start offset parameter value included in the second DRX configuration with a respective on-duration start offset parameter value included in the configuration information associated with the second network entity; or
replace a DRX cycle duration parameter value included in the second DRX configuration with a respective cycle duration parameter value included in the configuration information associated with the second network entity.

25. The first network entity of claim 23, wherein the configuration information associated with the second network entity includes one or more of a DRX configuration associated with the second network entity or a DTX configuration associated with the second network entity.

26. The first network entity of claim 1, wherein the first DRX configuration is associated with the DTX enabled state of the second network entity and a channel type associated with the downlink information.

27. The first network entity of claim 26, wherein the channel type associated with the downlink information is a configured grant Physical Uplink Shared Channel (PUSCH), a semi-persistent scheduled Physical Downlink Shared Channel (PDSCH), a Search Space Set (SSS), or an SSS group for Physical Downlink Control Channel (PDCCH) monitoring.

28. The first network entity of claim 26, wherein the channel type associated with the downlink information is associated with a Physical Uplink Control Channel (PUCCH) resource, a scheduling request, a random access resource, or an active bandwidth part (BWP).

29. The first network entity of claim 1, wherein a periodicity associated with the DTX enabled state is the same as a periodicity associated with a DTX disabled state of the second network entity, and wherein the periodicity is aligned with a periodicity of extended reality (XR) transmissions associated with an XR service of the first network entity.

30. The first network entity of claim 1, wherein one or more of a DTX cycle periodicity associated with the DTX enabled state or a DRX cycle periodicity associated with a DRX enabled state of the second network entity is aligned with a non-integer periodicity corresponding to an extended reality (XR) video generation rate of the first network entity.

31. The first network entity of claim 1, wherein:
a start time associated with the first DRX on-duration is the same as or after a start time associated with the DTX on-duration; and
an end time associated with the first DRX on-duration is the same as or before an end time associated with the DTX on-duration.

32. A first network entity for wireless communication, comprising:
at least one memory; and
at least one processor coupled to the at least one memory, wherein the at least one processor is configured to:
transmit information indicative of a first discontinuous reception (DRX) configuration for a second network entity, wherein the first DRX configuration is indicative of a first DRX on-duration of the second network entity;
transmit information indicative of a second DRX configuration for the second network entity, wherein one or more DRX configuration parameter values of the second DRX configuration are different from one or more DRX configuration parameter values of the first DRX configuration;
determine a discontinuous transmission (DTX) enabled state of the first network entity, wherein the DTX enabled state corresponds to a DTX on-duration of the first network entity, and wherein the first DRX on-duration is within the DTX on-duration of the first network entity; and
transmit, to the second network entity, downlink information during the first DRX on-duration.

33. The first network entity of claim 32, wherein:
the first DRX configuration is associated with the DTX enabled state of the first network entity; and
the second DRX configuration is associated with a DTX disabled state of the first network entity.

34. The first network entity of claim 32, wherein the DTX enabled state is aligned with a DRX enabled state of the first network entity, based on:
a periodicity of the DTX enabled state being a multiple of a periodicity of a DRX enabled state of the first network entity or a periodicity of the DRX enabled state being a multiple of a periodicity of a DTX enabled state of the first network entity; and
at least a portion of the DTX on-duration corresponding to the DTX enabled state overlapping with at least a portion of a DRX on-duration corresponding to the DRX enabled state.

35. The first network entity of claim 34, wherein:
the periodicity of the DTX enabled state is the same as the periodicity of the DRX enabled state; and
the DTX enabled state is aligned with the DRX enabled state based on a DTX on-duration start offset associated with the periodicity of the DTX enabled state being the same as a DRX on-duration start offset associated with the periodicity of the DRX enabled state.

36. The first network entity of claim 32, wherein the at least one processor is configured to:
transmit, to the second network entity, information indicative of the DTX enabled state of the first network entity.

37. The first network entity of claim 32, wherein the at least one processor is configured to:
indicate, to the second network entity, the DTX enabled state of the first network entity based on transmission or non-transmission of a signal relative to a period of time.

38. The first network entity of claim 37, wherein the at least one processor is configured to:
indicate the DTX enabled state of the first network entity based on non-transmission of the signal relative to the period of time.

39. The first network entity of claim 37, wherein the at least one processor is configured to:
indicate a DTX disabled state of the first network entity based on transmission of the signal relative to the period of time.

40. The first network entity of claim 32, wherein:
the first DRX configuration includes a first plurality of values, wherein each value of the first plurality of values corresponds to a respective DRX configuration parameter of a plurality of DRX configuration parameters;
the second DRX configuration includes a second plurality of values, wherein each value of the second plurality of values corresponds to a respective DRX configuration parameter of the plurality of DRX configuration parameters; and
at least one value of the second plurality of values corresponds to a particular DRX configuration parameter and is different from at least one value of the first plurality of values corresponding to the particular DRX configuration parameter.

41. The first network entity of claim 40, wherein the particular DRX configuration parameter includes one or more of a DRX on-duration value, a DRX on-duration start offset value, a DRX cycle duration value, a DRX on-duration timer value, a DRX inactivity timer value, a downlink (DL) retransmission timer value, an uplink (UL) retransmission timer value, a DL round trip time (RTT) timer value, or an UL RTT timer value.
